(19) United States
(12) Patent Application Publication
(10) Pub. No.: US 2010/0252648 A1
(43) Pub. Date: Oct. 7, 2010

(54) Climate Processor

(76) Inventor: Nicholas Paul Robinson, Cottingham (GB)

Correspondence Address: Nicholas Paul Robinson, 17 West End Road, Cottingham, E. Yorkshire, HU16 5PL, GB

(21) Appl. No.: 12/698,848

(22) Filed: Feb. 2, 2010

(30) Foreign Application Priority Data
Aug. 21, 2007 (GB) 0716285
Oct. 17, 2007 (GB) 0720463
Feb. 19, 2008 (GB) 0802955
Aug. 20, 2008 (GB) 2 452 152 A

(51) Int. Cl. A01G 15/00

(52) U.S. Cl. 239/14.1

(57) ABSTRACT

A climate processor having virtual estuaries which enable large strips of land to act like real water estuaries thereby providing a means of climate control overhead. Said estuaries are also used to prevent polar isotherm migration, melting ice shelves, vortical storm formation and migration from lateral coastal airflow. Said estuaries are formed between two parallel-laid thermal belts formed from artificial surface whitening and jet contrails. The surface whitening can be laid down as a foam or gel and deployed overhead as a high level aviation propellant. The belts may be applied daily and dissipate as the day progresses and subsequently warms. Commercial aircraft flights may be readjusted based on the placement of the artificial estuaries. Also claimed are an aerial deployment system for the foam, a high-level aviation propellant system, a carbon trading system for commercial airlines, a “Russian Doll” gas mixing device and a range of suitable foams.

This invention relates to a climate processor with virtual estuaries facilitating combined global climate control, streaming, zoning, cooling, greening and stabilisation.

Facilitating moisture transport overland and the carbon storage offsetting through diverting frequently flown commercial flight routes overhead deploying wet-burning and conventional aviation fuels overhead to prevent the effects of global warming, the climate processor provides summer daytime estuarial solar blocking climate buffering and white planet emulation, laid also as foam strips on the threatened surface terrain by a fleet of multi-role aircraft capable of carrying and deploying large quantities of water and foams for extended periods of spraying and distances over land.

The climate processor is also advantageously deployed aerially so providing an energy-secure commercial carbon-offsetting location over all terrain and hence a modus operandi for airlines and energy companies wishing to fly over and to mine polar oil and gas fields whilst maintaining and repairing the polar ice caps, preserving rain forests, greening deserts and irrigating crops to earn carbon credits from these carbon offsetting activities.

The device is deployed in multiple latitudinal-following strategic geo locations forming planetary rings to bound and white ice-wall de couple, buffer and contain neighbouring climactic zones including air streams especially the Jet Stream to prevent or ‘ice wall’ them from straying north and south and inter-mixing. Evaporative surface cooling blocks polar migration of isotherms in summer and according to lie-of-land enhancing broadening and completing real rivers estuaries plains mountains and valleys.

Virtual Estuary Definition

The virtual estuary device is defined herein as a long and wide strip of air-moistened land acting as a cool heatsink seasonal and diurnal breather that is made into a white-ice walled channel to behave in the same way as a real estuary with water thermally, thereby also attracting its own local estuarial weather system overhead like a real estuary, with frequently-flown daily jet contrails laid overhead assisting surface water solar-driven precipitation, evaporation, transport and solar heat blocking overhead. An icewall is a cold firewall which can be white and or cold.

By de-coupling said strip of land mass rather than water held thermally captive between and by colder white ice walled laid foam banks, the device is made to behave thermally like estuarial water with reduced diurnal temperature variation. This thereby attracts its' own re-circulating weather system above. The system acts as a thermal corridor, walled by thermal curtains of sink air spilling inland over said cold white icewall surface banks and assisted by and as a development from natural features to include mountain ridges cliffs and valleys and real drought-threatened rivers and estuaries.

Frequent summer AM daytime flights routed overhead create solar solar blocking of said strips central heatsink breather channel with jet contrails deposited overhead to reduce its daytime temperature variation creating a differential lag between the colder-biased container banks, drawing the chilled sink air over its central surface. The pressure differential created between said thermal sink curtains creates a rising core thermal curtain PM, driving said local weather system in a diurnal cycle.

Said strip of land has moisture retention which allows its greening, creating and enhancing microclimates to make it self-sustaining in the absence of aerial white ice-walled bank deployment, but with continued frequently-flown aerial daytime jet contrail deployment overhead.

Said foams may also be deployed over areas of greening supplied by an anaerobic digester via a blimp providing said greening at low-level from product-propellant stores combined nutrients irrigation and biogas.

According to the present invention there is provided:

A climate processor with one or more virtual estuaries comprising: two long strips of chilling white artificial and or natural surfaced terrain masses bounding a central wide strip of cooled terrain mass forming an icewalled thermal channel made to behave like a real estuary of water thermodynamically to conduct weather systems overhead providing a combined means of climate control streaming zoning greening cooling and stabilisation,

And additionally; a surface-whitening system comprising gel foams, a surface whitening deployment system comprising primarily a fleet of multi-role aircraft, an aerial deployment system consisting of a wet-burning aviation fuel, an airline and energy company modus operandi for carbon-offsetting flights and polar oil and gas mining activities and a Russian doll sorber.

The invention will now be described as six interdependent inventions in sections:

Section 1: The Climate Processor with Virtual Estuaries

Section 2: The Climate Processor with Surface Deployment System comprising a fleet of Multi-Role Aircraft

Section 3: The Climate Processor with Aerial Deployment System comprising a High-Level Aviation Propellant

Section 4: The Climate Processor with Airline and Energy Company Micro Credit-Trading System forming a Modus Operandi for carbon-offsetting commercial flights and Polar mining during their daily commercial activities to lay and maintain said virtual estuaries.

Section 5: The Climate Processor with Tunnelling Russian Doll Sorber

Section 6: The Climate Processor with Surface Whitening System comprising Gel Foams

Referring to Section 1

The climate processor comprises a polar latitudinal hierarchy of increasingly colder ice-walled virtual estuaries combined with natural terrain forming latitudinal white walled planet rings bounding and bisecting adjacent warmer and colder climactic zones.

Multiple parallel laid virtual estuaries laid 100s of kms apart create seasonal low-speed high capacity captive land breather-blocker heatsinks within the bounded region, further decoupling interfacing adjacent land masses to the north and south, with said diurnal high-speed breather-blocker banks maintaining a temperature differential between said adjacent land masses thereby trapping the polar seasonal migration of land isotherms in its heatsink to prevent the season-on-season polar migration of said isotherms. To prevent the seasonal migration of isotherms, the 45 and 50-degree North belts are laid in sequence through the summer followed by the 65 and 70 degree belts North in autumn when maximum polar melting occurs. Advantageously this means said belt deployment is sequential, maximising fleet utilisation throughout the year, with the sequence may be repeated in Winter at the South Pole at 65 and 70 degrees South as described, with tropical belts and rain forests laid throughout the remainder of the year to disrupt storms.

Advantageously, multiple virtual estuaries laid several 100s of kms apart or by about 5 degrees latitude can capture, channel, and entrain a jet or Gulf Air stream overhead in a latitudinal planet ring to provide said means of climate streaming, when two virtual estuaries are laid on the terrain for example at 45 and 50 deg N they buffer arctic from temperate climactic zones in summer, at 20 and 25 deg N they buffer temperate from tropical equatorial climactic zones to prevent tropical storm seeding over sea and propagation over land plant and populated areas and at 65 and 70 deg N where they buffer polar from arctic climactic zones. Said estuary pairs form multiple planet rings containing larger estuaries, providing said means of climate zoning by ice-walling the global climate into zones with thermal curtains to provide said climactic stabilisation whilst preventing global polar warming.

Functional Description of One Virtual Estuary

Since the ground comprising the Earth's surface layer rises in temperature during daytime solar heating more rapidly than water, solar ground breather-blockers are required to slow said strips of land warming during the day and shed its accumulated heat at night during periods of cooling to emulate the thermal behaviour of estuary water.

This differential solar heating effect is known to drive the weather overhead creating diurnal summer daytime onshore and evening offshore winds and hence thermals and sink air currents inland. This weather in turn creates a warmer coastal climate in the U.K. winter for example, transferring heat and moisture from the warm Gulf Stream overland, with areas far inland becoming much colder in Central Europe.

The climactic summer zone-buffering effect of the virtual estuaries comprising the climate processor therefore create thermal falling air sink curtains over each cold evaporative foam cooling white ice wall-laid bank during the day, together with jet contrail-enhanced cloud cover resulting from airborne moisture as drawn overhead by daytime onshore winds over the central breather-blocker bounded landmass.

Airborne CO2 emissions persisting overnight overwhelms nighttime planetary cooling or breathing re-radiating stored heat into space. The climate processor stabilises the season on season atmospheric warming effect with thermal curtains to prevent polar ice cap melting. Additionally, successive planet rings comprising estuarial pairs located 1000s of kms apart zone or ice-wall climactic regions with significantly different levels of solar warming into the accepted categories of tropical, temperate, arctic and polar climate.

The climate processor comprises in this sectional invention:

1. a technical array of thermally decoupled heatsinked land masses (Section 1), further Sections will also be described:

2. a combination of climate regulator devices and surface deployment systems (Section 2),

3. a rapidly precipitating, low CO2 emissions dense-white solar-reflective aviation propellant system comprising a pumpable gel fluid and fixed tank substrate sorber (Section 3)

4. a commercial (frequently flown re-directed commercial flights) strategy forming an airline and energy company modus operandi: (Section 4),

5. a pumpable fuel media variable geometry fluid sorber (Section 5) and

6. a range of suitable gel foams (Section 6).

The airline and energy company modus operandi is determined by economic viability cost and necessity to limit the effects of global warming by trapping polar-migrating isotherms in the ground and weather systems overhead, thereby providing carbon offsetting, climate control and also moisture transport and tropical climate weather stabilisation to combat desertification, facilitating greening and energy secure commercial operation including the mining of polar oil gas and other minerals without incurring further rises in sea levels.

Channelling the Gulf Stream and other moist air streams over threatened land and thereby buffering and protecting the cooler polar hinterland climate beyond from tropospheric warming, the virtual estuary climate regulator device also supplies airborne moisture transport for remote precipitation over drought-threatened land to combat desertification, acting as a white planet emulator.

Multiple estuary devices are laid in belts on thaw-threatened land, ice caps and seas and from the air forming multiple solar reflective planet rings bounded by virtual estuaries, forming thermal corridors in each hemisphere and thereby providing two statically stable hierarchical-poled, non-linear control systems with an unstable shared equatorial base. One or more planet rings per pole provide increasing Pole stability, bounded by two or more virtual estuaries laid by example along latitudinal intervals over landmasses bounding the Northern snowline at 45°-50° N with a further ring laid at 65°-70° N to contain the Northern Polar region bounded by the colder Arctic Circle.

Multiple estuary devices forming partial planet rings over landmasses are also laid forming thermal corridors for thermal moisture transport over areas of drought-threatened equatorial rain forest and desertification over tropical landmasses by example at 20° N-25° N to contain the Tropic of Cancer and similarly in the Southerly Latitudes dependent on land mass reclamation requirements.

A white planet is a cool planet and therefore thermal blockers comprising latitudinal belts of surface whitening and or white jet contrails overhead are deployed by said devices and deployment systems to provide white planet emulation. Jet contrails complimenting the planetary rings are flown over the sea and over land and or in combination with said belts of surface whitening deployed over terrain comprising land ice desertification and permafrost to impart moisture through the air to the surface gap of said bounded estuarial thermal breather to make it behave thermally like water as described.

Surface whitening belts and jet contrails are laid during periods of daylight along given latitudes, also described as the airline commercial carbon-offsetting modus operandi, to block solar warming in calm warm weather and emulate moderate daily or scheduled regular snowfall in summer. This restores the climate balance by creating arctic temperate and tropical buffer zones, which comprise thermal breathers emulating climactic streams bounded by thermal estuaries that are held within a hierarchy of increasingly stable zoned intermediate temperature ranges.

Advantageously the surface ring whitening laid below and jet contrails flown over-head are mutually reinforcing, providing an anthropogenic carbon dioxide (CO2) offsetting location. Global warming is caused by polar land isotherm migration brought about by short-term weather changes, longer-term climate trends, latitudinal shifts and conductive warming through neighbouring land and sea masses. As the troposphere warms, the land below also warms; which over longer periods of time causes the melting of the permafrost and ice sheets from above.

By regulating the land isotherm migration with a single surface-insulating solar-reflecting cold white belt coating, as described as an ice-wall thermal solar heat blocking junction, it is possible to achieve a limited localised effect on the land suitable for temporary snowline ice cap and pipeline foundation protection from strudel scour which involves the seasonal thawing of ice and permafrost undermining structure and foundations. This effect creates a microclimate over the ground, similar to a forest canopy or as provided by on-land location e.g. in a cove or valley or relative to a single coastline snowline or an estuary bank. This single belt coating does not prevent the prevailing warmer climate spreading as a front overhead to the cooler polar region behind however, unless it is 10 kms or more wide, making artificial implementation prohibitively expensive, with further multiple estuaries required hundreds kms apart comprising a 5° wide latitudinal planet ring or about 555 km in width to form buffer and contain said climactic streams forming overhead.

In order to prevent the season-on-season polar migration of land isotherms, the climate overhead also has to be influenced in such a way as to promote colder re-circulating air flow over the land affected and land effecting it to bring the climate shift and change within the locus of control.

It is known also that wide estuaries of seawater have an influence on the weather overhead, for example the mouth of the Humber Estuary, whereas the narrower rivers do not, for example the Mersey. Adjacent landmasses comprising the north and south banks of the estuary are differentially affected, having occasionally different prevailing weather systems, with the estuary having its own predominant weather system overhead. This localised weather variation is caused by the sufficiently wide expanse of water being maintained at an even temperature, which holds stored heat and acts as an intermediate thermal buffer zone between the north and south banks. This creates a breather, which loses heat into the cool air at night and absorbs heat from the warmer air during the day.

A processor is required that both emulates cold air virtual estuary devices and also provides land insulation for blocking polar migrating isotherms creating a hierarchy of increasingly colder virtual estuaries over land.

The virtual estuary device requires to be sufficiently wide for example 20 kms or greater in order to facilitate localise and retain an overhead weather system and sufficiently long for example 200 kms or longer.

The devices also have to be latitude following in order to facilitate a thermal corridor to draw and propagate the localised and retained leading and trailing-edge weather fronts held in place by Coreolis forces and thermal curtains. These forces are caused by the differential latitudinal and longitudinal geo-rotation effects diving the adjacent weather systems and especially their' coalescing weather fronts and hence climate change ultimately. Said forces are known to drive the rotation of the great ocean currents and are also known as to cause estuarial river flow, salt and fresh water mixing as well as weather systems.

Switched thermal foam decayed night breathers and freshly laid day blockers facilitate non-linear diurnal and seasonal thermodynamic heat flow control laid comprising said banks of said estuary device. This is a thermal ratchet or rectifier effect allowing restricted one-way heat flow into the land as isotherms and thermals into the ground heatsink, which can be achieved through the selective switched daytime application of aerosol ground sprinkled solar reflective insulative white foams over the banks and white moisture-laden solar reflective white CO2-containing jet contrails over the ground forming said ground bounded by the banks.

The foams gasify and boil-off out of supersaturated solution on collapse during the late daytime heat changing roles from thermal blockers into breathers, causing evaporative land cooling and these coatings are applied to emulate light persistent summer snowfall over the ground to prevent its warming. This can provide just sufficient daytime cover to prevent solar warming in the warmer daytime air whilst liquefying out into slush overnight allowing the land and ice to breathe and loose heat into the cooler night air as it is conducted upwards from deep within the Earth. Polar ice is thereby being cooled to prevent melting continuing out of season.

Estuaries, The Jet Stream, tidal river bores and seiches, The San Francisco Bay Estuary and Valley, The Severn Bore and horizontal vortical rolling weather fronts to include cloud fronts in Australia and sandstorms are known to occur in Nature along with the rain forests and these form the ‘prior art’, along with jet contrails cliff faces and mountain ridges as examples of separately-occurring rather than combined surface and airborne standing wave fronts known to affect and propagate the climate overhead as described herein.

The invention will now be described on-ground, in-ground and over-ground respectively:

On-Ground and In-Ground

Concentric planetary surface ring whitening, deployed in multiple parallel belts at high polar and other latitudes and or according to lie of land bound a land heatsink comprising the estuarial seasonal breather of virtual water with said surface ring whitening also described as ice-wall thermal solar blockers constituting the virtual trailing-edge north and leading-edge south banks. Said ice-wall thermal blockers are sufficiently wide for example 500 metres to provide sufficient depth to prevent the lateral polar migration of isotherms at up to 500 metres underground.

Said ice-walled solar blocking breather heatsink is thereby held within an intermediate temperature range and cold-biased to trap or block polar-migrating summer isotherms. The breather heatsinks junction is also cold-biased by said aerial estuarial blocker and moisture transport creating solar reflective cloud canopy during daylight.

The virtual estuary is deployed between two or more adjacent land permafrost tundra desertification and or ice masses of different temperatures extending out over sea overhead by jet contrails as described to prevent polar isotherm migration. Said junction is biased towards the colder end heatsink junction as described, with virtual banks forming leading and trailing edge ice-wall blocker junctions made from ice aerosols snow slush foams and precipitation and other reflective white cool materials of natural and or man-made origin or including cliffs and terrain in any combination thereof.

Said ice-wall junctions also described as white walls have a sprinkler device delivery system, applying a foam blanket of gasified gel colloid product-propellant aerosols during early part of the day which decays gradually throughout the day by nightfall providing thermal ground protection through ground insulation and surface reflection. Advantageously the surface whitening foam application can source its propellant from CO2, creating an anthropogenic CO2 emission offsetting demand for restoring the global climactic balance.

Over Ground

The virtual estuary creates a thermal cold air corridor forming above the breather which is bounded by said virtual banks with a helical air flow over-ground and unbounded over sea. During the latter half of the day, thermals predominate over the land breather drawing cooler off-shore colder northerly air on-shore over the trailing edge of warmed land breather comprising the virtual estuary and during the early part of the day sinks predominate where the cooled breather cools the air on-shore forcing it off-shore in the opposite direction. This creates a re-circulating local diurnal weather system. During the night the weather system ceases to circulate as solar warming drives it.

The banks provide climate control, preventing the spread of air-streams outside the corridor and attracting and maintaining existing air-streams overhead.

The thermal cold air corridor has a helical diurnal airflow which is frequently flown through and over only during periods of daylight by aircraft. Deploying a wet burning aviation fuel that produces dense white moist solar reflective contrails. Said contrails act along with clouds drawn and conducted overhead as blockers reflecting solar radiation back out into space during daylight and breathers, dispersing rapidly at nightfall aided by their high moisture content precipitating out their CO2 emissions into the sinking air of the thermal corridor, aided by its diurnal airflow. This rapid contrail precipitation prevents CO2 build-up in the troposphere causing internal thermal atmospheric reflection at night, which assists with cooling the land below in shadow during daylight.

Said land also comprises the thermal heatsink held between leading and trailing edge ice-walls as described. Advantageously; said virtual estuary draws and propagates moisture-laden cold air from the sea and said jet contrails over land and sea providing additional irrigation by moisture transport for areas threatened with desertification, melting ice, permafrost, strudel-scour and drought.

The Invention (Section 1) will now be further described with reference to the following figures:

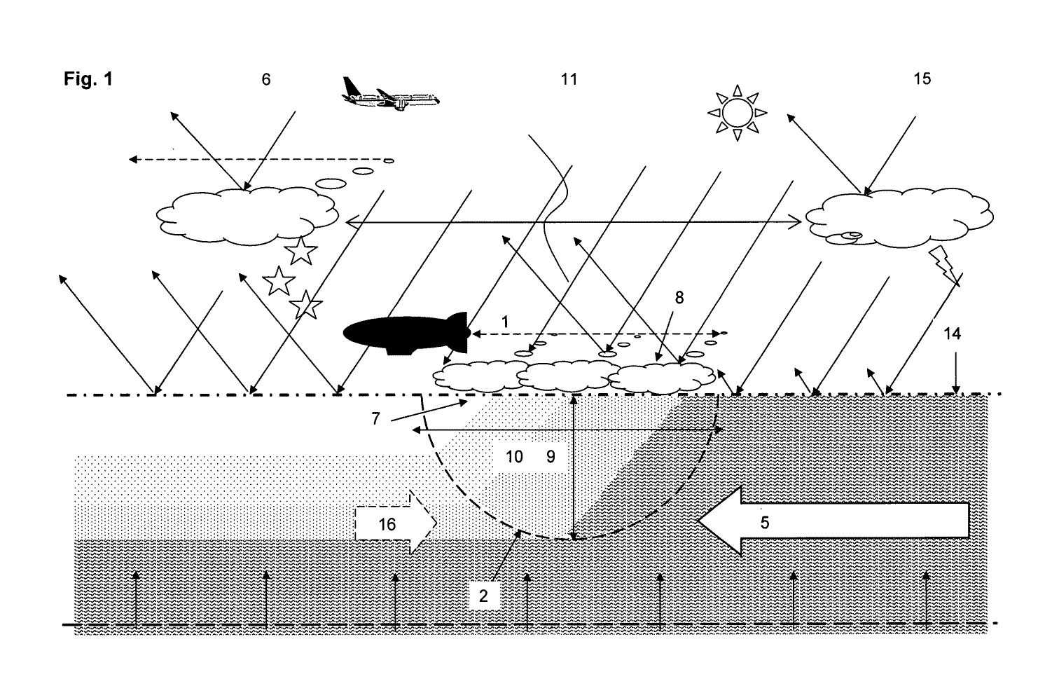

FIG. 1 shows a single leading edge thermal blocker ice-wall junction in sectional view in schematic form.

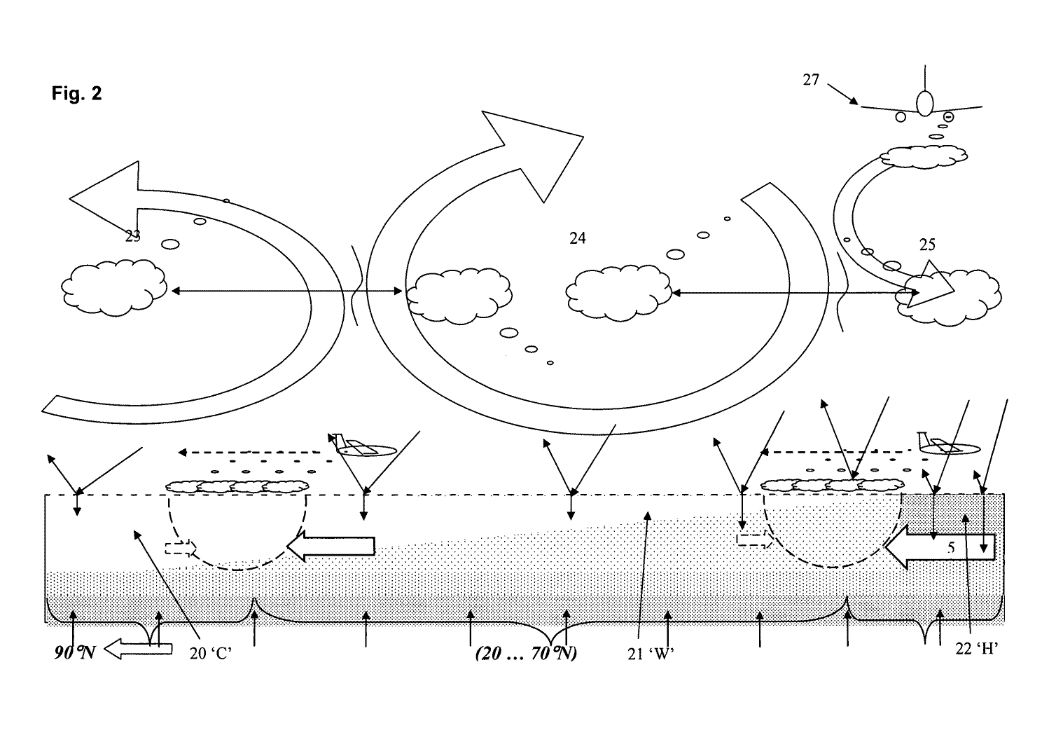

FIG. 2 shows the leading and trailing edge ice wall thermal ice blockers bounding a land heatsink seasonal breather maintained at an intermediate temperature, cold-biased in sectional view in schematic form.

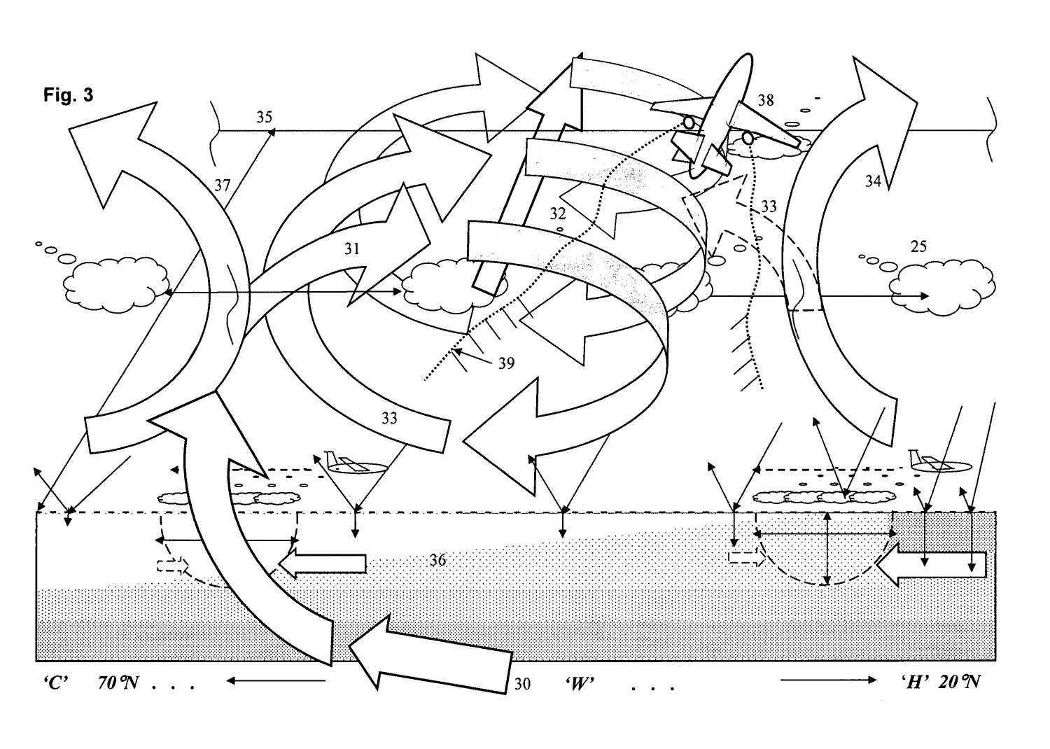

FIG. 3 shows in orthographic projection the ‘worm drive’ virtual estuary cold air thermal corridor with helical airflow in schematic form and wet-burning aviation fuel contrails laid overlaid by commercial airlines.

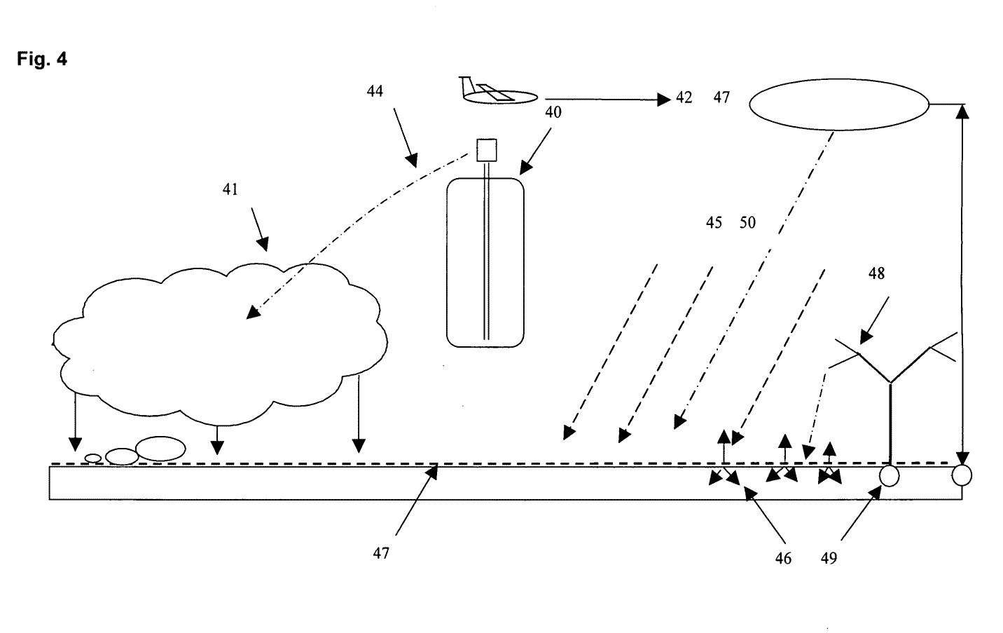

FIG. 4 shows the CO2 foam sprinkler deployment system and the product-propellant aerosol store and sprinkler array devices in elevation schematic.

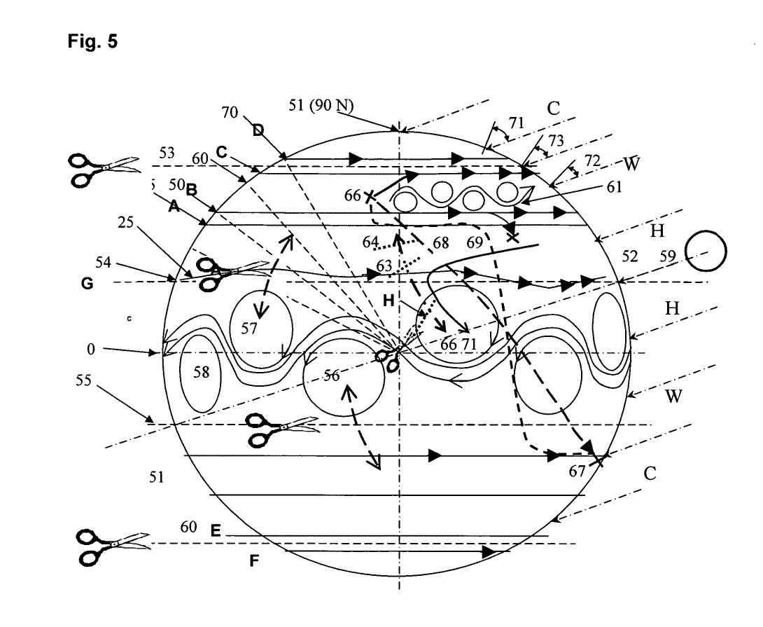

FIG. 5 shows the white Planet rings bounding virtual estuaries forming the Airline carbon-offsetting modus operandi and tropical storm disrupters.

Referring to FIG. 1; the daytime solar rays are reflected back from the surface by the foam blocker 8 which also provides thermal conductive and convective insulation to the ground ice sheet slush strudel scour tundra and or permafrost below 7. Polar-migrating isotherm 5 is shown blocked by the heatsink thermal junction boundary 2, which is cold-biased by the accumulative daily cooling action of the surface foam. Reverse isotherm flow 16 is reduced. The depth 9 and width 10 of the thermal blocker are related as shown, with the width of foam application chosen to be just sufficient to achieve summer blocking through lateral ground conduction as described.

The gasified gel aerosol foam is applied in this example by an adapted low-flying crop sprayer aircraft with a wing or boom mounted sprinkler array 1. The passing weather front is shown temporarily located overhead 11, 6, and 15. The upward pointing vertical arrows from the bottom of the figure show the direction of heat flow from the Earth's internal warming. This has to be balanced by allowing the land to breathe and so loose heat from the surface overnight, rather than providing round-the-clock surface insulation in the absence of solar surface warming which would likely cause a build-up of subterranean warming, undermining the main purpose to provide polar cooling.

Referring to FIG. 2; the intermediate heatsink breather zone comprising the gap or ‘water’ of the virtual estuary is marked ‘W’. The ice-walled virtual estuary acts similarly to a fridge freezer with hot outer wall ‘H’ being equivalent to room temperature, warm ‘W’ being equivalent to the central foam-filled insulator wall temperature and ‘C’ being equivalent to the cold inner wall temperature storing the contents. The fridge freezer analogy is further extended by setting the thermostat just above freezing to allow for the door to be left open overnight in the cooler air to lose energy and breathe by radiating it back out to space through the atmosphere. Two thermal junctions are also shown and can be likened to two layers of said fridge freezer's foam insulation, comprising the leading and trailing edges of the cold white ice-wall, as H/W and W/C junctions, laid in latitude-following belts at around 70 degrees North as shown or along thaw-threatened snowlines, ice sheets, coast lines, terrain and permafrost.

The cold polar land heatsink 20 is interfaced with the junction heatsink 21 held at an intermediate temperature, which is then interfaced with the warmed land 22. As the polar migrating land isotherm 5 (from right) passes through the first thermal foam blocker (from right) it is reduced in strength and absorbed and trapped in the central region 21, prevented from migrating through the upper thermal blocker into the polar hinterland 20 (left). Because the temperature differential of the intermediate zone is held at an intermediate temperature by the cooler air above and the limiting lateral land heat conduction rate from the right and below the ground surface as described, the heat and hence isotherm travel more slowly than would otherwise be the case. They are reflected back after only just reaching the left hand side of the ice-wall diminished in strength at the end of the summer season.

The virtual north and south bank white rings comprising leading and trailing edge thermal blocker junctions, entrained local estuarial weather systems and air streams are also shown overhead 23 24 25. Colder polar air travels along the cold ground ‘C’ from the North Pole flowing over the cold-biased trailing-edge thermal blocker junction's ice-wall (left). Because the air circulating over the central heatsink land breather is warmed to an intermediate temperature ‘W’ as described, signifying warm in summer, the air rises forming a weather front and thermals overhead as shown by the arrow.

The virtual estuary has a north bank (trailing-edge, left) and a south bank (leading edge, right). The leading edge bank varies in temperature above freezing in summer comprising a cold-biased white-wall rather than a frozen ice-wall junction, admitting weakened polar migrating isotherms into the estuary heatsink. This is known as a fallback position, limiting the seasonal retreat of the captured permafrost ice and snowline to the trailing-edge ice-wall north bank, which is maintained below freezing, preventing further polar isotherm migration in summer.

The warmed hot air returning from the warmer temperate regions to the south over hotter ground ‘H’ falls to the ground cooling overnight and so completing its convective cycle to be returned to the temperate regions to the south of the virtual estuary's chilling south bank (right). The local estuarial weather system held at intermediate temperature ‘W’ (centre) acts like an idler wheel between the two gear wheels in the mechanical analogy, re-circulating its own intermediate temperature ‘W’ air.

Commercial aircraft 27 is shown flying a frequent route along a segment parallel the virtual estuary upwind of the weather front sink air as diverted from its great circle flight route where convenient adjacent to the ice wall. By flying this diverted route, it is possible to carbon offset many long-haul east-west commercial air flights when burning the aviation fuel mixture during daylight in location adjacent to or over the virtual estuary thereby providing the airline modus operandi as described. The curved arrow represents the direction of flow of the rapidly precipitating, moisture-laden jet contrail being drawn down into the re-circulating cold air corridor as sink air in the evening and overnight where it eventually precipitates.

The coalescing weather systems as so described maintain the chaotic neutrally stable climate system in a stable bounded location-based hierarchical control state, as counter-rotating vortices attract and same-rotating vortices repel each other. The idler wheel worm drive mechanical analogue can thus play a neutral but important role interfacing and buffering the two weather systems around the Arctic and Antarctic Circles located at latitudes between 65 and 70 degrees North and South and around the Tropics of Cancer and Capricorn located between 20 and 25 Degrees North and South.

Said thermal H/W and W/C junctions form said container banks of said virtual estuary and are likened in function to a switched MOSFET electronic semi-conductor device of the prior art with a gap or channel resisting or blocking lateral flow conduction through said channels surface or tunnelling thermally below the surface.

Referring to FIG. 3; this is a 3D development of FIG. 2 showing how the virtual estuary cold air thermal corridor and hence ice-wall drives and is driven, affected and effected by adjacent weather fronts over-ground during the Polar Summer. The time lapse from the front to the end of the representation represents in idealised schematic form two days of diurnal airflow summer weather variation 37 and the airflow arrows are shown in 3D forming an incomplete double helix vortical flow 32, 33. The second helix 33 is shown dashed to show (anti)-cyclonic weather systems impinging.

The tropospheric air e.g. the Atlantic Gulf Stream air 30 is free under starting and entry conditions to enter from over the sea with its accompanying moisture laden weather system over the westerly land surface from the right-hand thermal heat blocker ice-wall solar heat blocking thermal junction with the warmer moist air admitted into the thermal corridor 32 where it is mixed with the cooler polar air 31. This mixing 32, 33 maintains the said ice-wall at an intermediate temperature by surface convection forming a local estuarial weather system. The virtual estuary cold air thermal corridor 32 above ground compliments and reinforces the ice-wall in the ground 36, thus maintaining the buffer zone and ice-wall heatsink solar blocking thermal junction temperature at an intermediate level, so trapping the migrating isotherm and overhead weather system in combination with the above thermal blocker action as described in FIGS. 1 and 2.

Aircraft deploying wet-burning aviation fuels 38 flown frequently over the thermal corridor emit dense white moisture-laden jet contrails 39 and larger thermally reflective but invisible further CO2 jet contrails, both of which reflect solar rays during the day creating a thermal day blocker, but precipitate out rapidly at nightfall creating a thermal night breather. This allows ground cooling within the cold air corridor especially during the summer, reinforcing the ice-walled intermediate temperature-maintained cold land comprising the buffer zone heatsink as described. Civil aircraft when selectively deploying said wet-burning fuels at altitude have their flight plans modified to fly polar and other latitude-following routes over said thermal corridors where convenient with dense white moist contrail emissions restricted to daylight flights.

Additionally, the Coreolis forces caused by the Earth's rotation driving the interfacing warmer temperate cyclonic weather systems interface (known as weather fronts) cause the thermal cold air thermal corridor to be propelled anti-clockwise in the northern hemisphere through exchange of lateral kinetic wind energy 31 35 creating a stream of cooling air 32 in said thermal corridor with its own weather system to be propagated easterly around the arctic circle, thus reversing climate change as caused by polar and tropospheric global climate warming.

As the thermal corridor establishes itself, it's weather system traps re-circulating air between the thermal heat blockers, creating a stable cooling air stream 32 out of the Atlantic Gulf Stream 30 forming said source of warmed tropospheric air for starting conditions, which is directed and indeed extended around the pole and Arctic Circle over the frozen tundra and wastes of Northern Asia 36 to limit climate change.

The second ice wall solar heat blocking thermal junction (left) can comprise a snowline, coast, ice sheet or any other natural cold terrain boundary with just the first junction laid artificially (right) to complete the ice-wall bounded heatsink (centre) and hence virtual cold air estuary as described.

Advantageously, the virtual estuary cold air thermal corridor can also be deployed over areas of desertification and drought including temperate and tropical latitudes as labelled in a series of latitudes 20 ° . . . 70° N.

Referring to FIG. 4; the surface foam thermal heat blocker 41 is applied during early daytime by an aerosol store 40, which consists of a pressurised tri-state, or other number of states gel product and CO2 propellant colloid. As the dense gel 44 inflates into a foam 41 over time, it can be sprayed backwards from an aircraft travelling at flight speed over the terrain 42, falling rapidly to the ground 43 without it blowing away whilst airborne as described and allowing it to attach itself to the ground by gel sticktion. Natural precipitation and repeated foam applications 45 aid the natural decay and CO2 ground re-deposition and absorbtion process 43, 46.

Natural and artificial surface moisture layers resulting from rain snowfall deposition and collapsed foam shown dashed 47 contain supersaturated, ground-chilled expanded CO2, which is partially absorbed into the ground 46 which acts as an effective sorber on re-gelation (freezing over) at night. During the following daytime hours during periods of solar land surface warming, the CO2 boils off out of said supersaturated solution, creating evaporative polar cooling as the ground sorber loses its latent heat of state change from solid sublimation through liquid evaporation into vapour and gas atmospheric emissions. This thermal breathing cools the summer warming heatsink ground temperatures as required for the white ice-walls' summer leading and trailing edge foam belts as described.

Alternative aerial gel foam delivery systems include artificial tree sprinkler arrays 48, land pipelines 49 and airships 47, 50 and said aircraft, which can be used advantageously in combination or separately as shown.

Referring to FIG. 5; The Earth 51 is shown in elevation in the orbital plane shown chained 59 with the sun 52 at the summer solstice during peak of the arctic summer. The Arctic Circle 53 and the tropic of cancer 54 latitudes are shown dashed in the northern hemisphere with the corresponding southern hemisphere latitudes below. The shared tropical region as bounded by the tropics of Capricorn 55 and Cancer is chaotic and unstable with circular cyclonic weather systems overlaid forming an equatorial vortex street of rotating and counter-rotating cyclonic weather systems 56 57 58.

Aircraft fly frequently along preferential ringed carbon-offsetting flight paths at controlled latitudes 25, 50, 55, 65 and 70 deg. N and S during daylight as shown by arrowheads forming planet rings with their jet contrails deployed over land and sea. The operation is mirrored with commercial flights routed similarly deployed over the southern hemisphere during daylight as shown 60.

Interfacing the unstable base, the 25 degree N planet ring is laid down primarily by flown jet contrails overhead into sink air and this weather front is drawn up and down in latitude and maintained in a less stable position over ground and sea by the equatorial climactic stream shown as two curved lines 0 centrally. The adjacent planet ring 45 50, laid between 45-50 Degrees N, is higher up the control hierarchy and more positionally stable, maintaining its latitudinal position and temperature gradient within narrower bounds and white ice-walling the temperate weather systems from the tropical weather systems providing climate control stabilisation as described below.

The 65-70 degrees N planet ring buffers the Arctic Circle and entrains The Gulf Stream 61 lending further stability to the polar climactic zone thereby controlling it by temperature and location above 70 degrees N.

Flight airports e.g. route terminuses are shown as crosses 66 67 showing flights diverted from their direct great circle routes 68 long dashed where convenient shown short dashed 69. The summertime seasonally hotter climactic regions are shown marked ‘H’ with the temperate zones interfacing marked ‘W’ which in turn interface with the polar and colder zones marked ‘W’. Said climactic zones form macroclimates as contained and buffered by said ice-walled thermal sink curtains forming latitudinal planet rings indicated by the scissors symbols, thus providing said climate processor with stabilisation and climate control. The Climate Processors climate control stability relating to increasing weather severity associated with global warming is provided by thermal curtains which prevent storm formation and deflect storms to sea, further buffering the temperate climactic zones. Tropical vortex storm seeding and propagation through stray equatorial hot air currents 56 57 mixing with cooler temperate zone-originating Westerlies 71 creating spin couples is prevented by said ice wall thermal curtains shown by scissors symbols creating thermal buffer zones of thermal sink air. Tornadoes, typhoons and hurricanes are thus prevented from forming migrating and straying outside the equatorial climactic zones and onto land threatening homesteads industrial land ports and shipping and harbours.

In addition, solar reflective foam belts are deployed as described over areas of landfall islands and sea water for example through The Gulf of Mexico, Cuba and at other orientations including coastal areas and mountain ranges 63 64, similar to groynes as deployed along the coastline pointing into the sea to prevent lateral coastal erosion, to prevent wind currents developing storm-seeding flowing off coastal escarpments to prevent the North-South polar migration of cooler air falling from mountain ridges for example The Sierra Madre Occidental 66. Tornado alleys are thus also directed by thermal curtains laid on the ground by said means in their paths to deflect them around homesteads, ports and areas of population to mitigate their effects.

The letters in bold A B C D E F G H indicate the surface belt-laying deployment sequence beginning with A in June, ending with H in May. This sequence, with overlap, permits the sequential North and South Polar isothermal protection from seasonally migrating isotherms followed by equatorial storm disruption and greening (G and H).

Referring again to FIG. 5 as an example of the planet behaving like an ideal un-disturbed gas planet with planet rings in mid-summer with the sun at its peak, the colder polar land mass lying predominantly from 70 to 90 degrees North 71 has a prevailing peak solar summer warming rate of cos (80−23)×240 Watts/square metre=130.7 Watts/sq metre of surface approximately whereas the temperate land lying at 50-65 deg North 72 has a prevailing peak solar warming rate of cos (57.5−23)×240 Watts/square metre=197.8 Watts/square metre of surface approximately, where 240 Watts/sq metre=power of solar energy falling from directly overhead in summer (23 deg. North) for a planet in a similar orbit to The Earth. Differential neighbouring zoned climate temperatures to the North and South are sufficiently small to be undermined by the persistent residual atmospheric CO2 contrail emissions at nighttime causing internal atmospheric reflection and blocking effect known as global atmospheric warming.

Said climate differentiation is maintained into increasing residual CO2 levels by said virtual estuaries deployed multiply forming wider planet rings or super estuaries as described.

The virtual estuary 73 sandwiched between said landmasses decouples them from each other thermally, creating an intermediate temperature zone at 67.5 deg North, forming an estuarial ‘breather’ emulating estuarial water.

Because the water temperature rises at a slower rate than that of the rocks and ground, the ground warms up more rapidly than the water or sea becoming hotter in temperature during the peak of the day, creating onshore breezes and thermals, and vice versa at sundown creating sinks over said land.

The moist air drawn overhead by the estuarial climate forming above as formed by cloud cover and augmented by jet contrail blockers, interacts with captive said land below causing solar blocking or shade from direct sunlight over the land which then warms more slowly than the neighbouring land masses during the day, causing the land to become cold-biased and behave thermally like estuarial water.

Section 2: Multi-Role Aircraft

Referring to Section 2; the surface deployment system comprises a multi-role aircraft fleet of docking airships and jet aircraft-harnessed hovercraft which are when deployed together to provide a means of transporting large volumes of water surfactant and CO2 over mixed terrain for deploying as CO2 water foams with air.

The foam surface laying capabilities and capacities will now be described:

a versatile multi-role cargo transport aircraft comprises docking wingtip airships, a bi-hull airship docking hovering catamaran platform structure housing a captive ageing commercial surplus re-cycled jet aircraft, a hover cushion, a spanned trailing edge cushion top with a solar collector-condenser, cushion skirting, a rear cushion flap tailgate, water tanks, a dual circuit heat exchanger, a water boiler, a CO2 gas cargo, a natural gas cargo, a gas fuel, helium lift gas, a water cargo, a gel surfactant cargo, pumped foam cushion sprinklers and inflatable internal gas chamber bags mounted within said hull or hulls providing light-as-air and heavier-than-air operational roles in:

1 its light-as-air flight role as un-docked airships for transporting the fuel gas cargo mixed with the helium lift gas within the same internal gas chamber sacks held within said hull compartments or gas bags propelled by said gas fuel, said propellant system and internal propulsion system on outward journey over large distances,

2 its light-as-air flight role as un-docked airships for transporting the CO2 as captured waste gas cargo from power stations with the helium lift gas held in separate gas bags propelled as above on return journey,

3 its heavier-than-air hover role for laying the CO2 gas cargo as foams and moisture on the mixed terrain including ground threatened permafrost snowlines desertification isotherm forest estuary breather forest fire fire break and or thaw-threatened ice sheet mountain ridge and or valley cliffs combined as described with said water and surfactant cargo as pumped via foam cushion sprinklers within the hover cushion as held in place overhead by said cushion skirting, and augmented by an external docked platform with ducted fan cushion and propulsion system.

The climate processor (Section 2) will now be described with reference to the following figures:

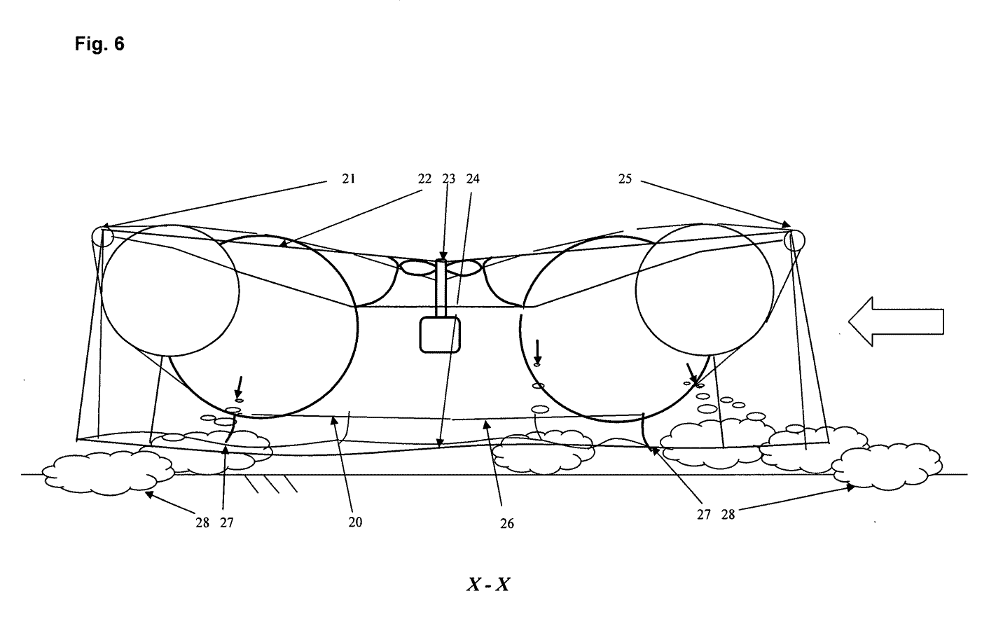

FIG. 6 shows the multi-role aircraft in sectional end elevation X-X.

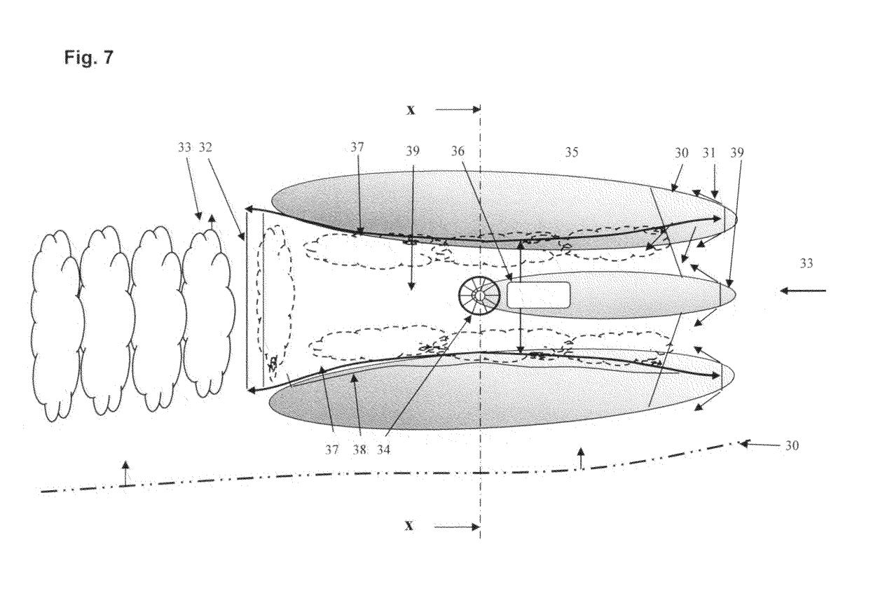

FIG. 7 shows the multi-role aircraft comprising two airships docked with a hovercraft forming a spanned bi-hull in plan view.

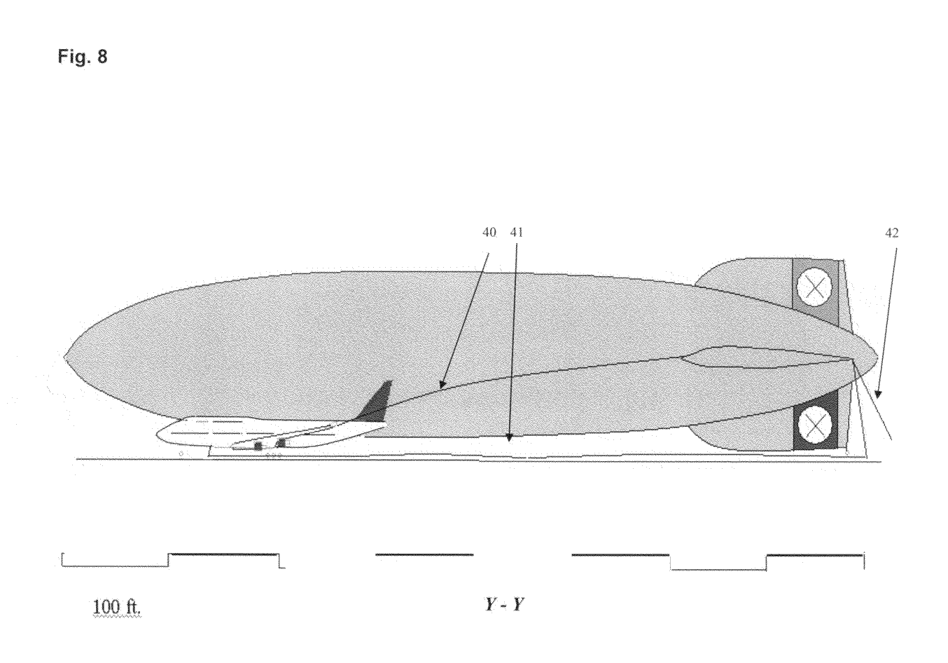

FIG. 8 shows the multi-role aircraft in sectional elevation Y-Y fitted with a central recycled old commercial jet aircraft fitted with two wingtip airships.

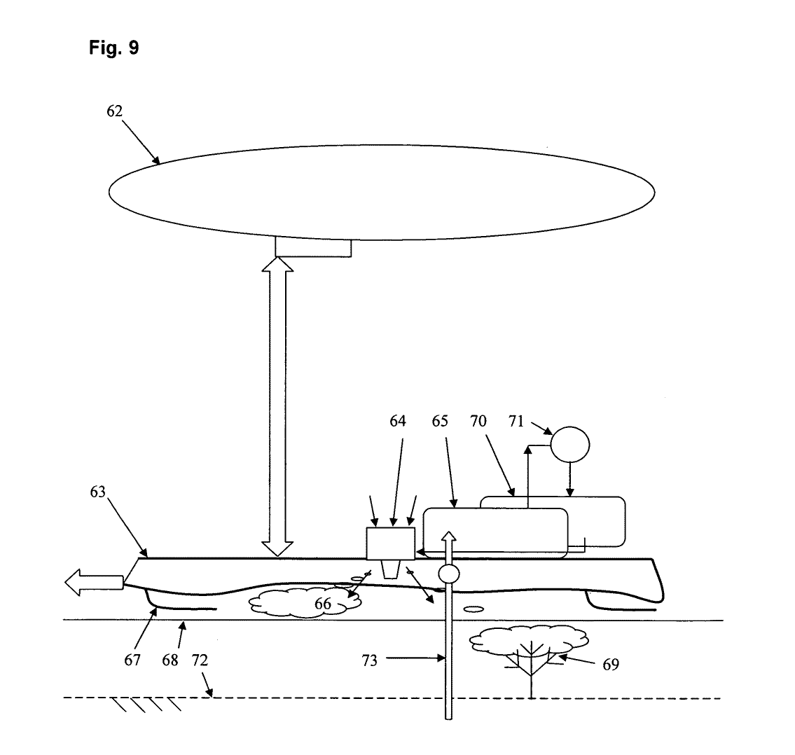

FIG. 9 shows in plan view the multi-role aircraft with docking airships and hovercraft also taking on board seawater.

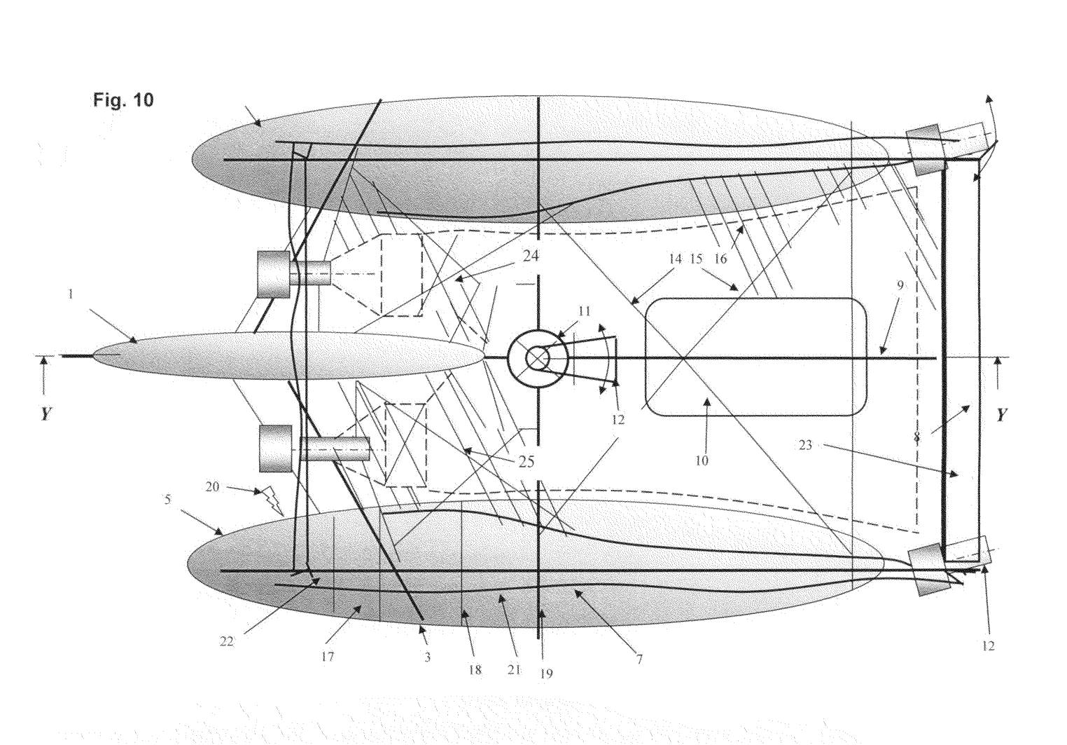

FIG. 10 shows the multi-role aircraft in plan sectional view.

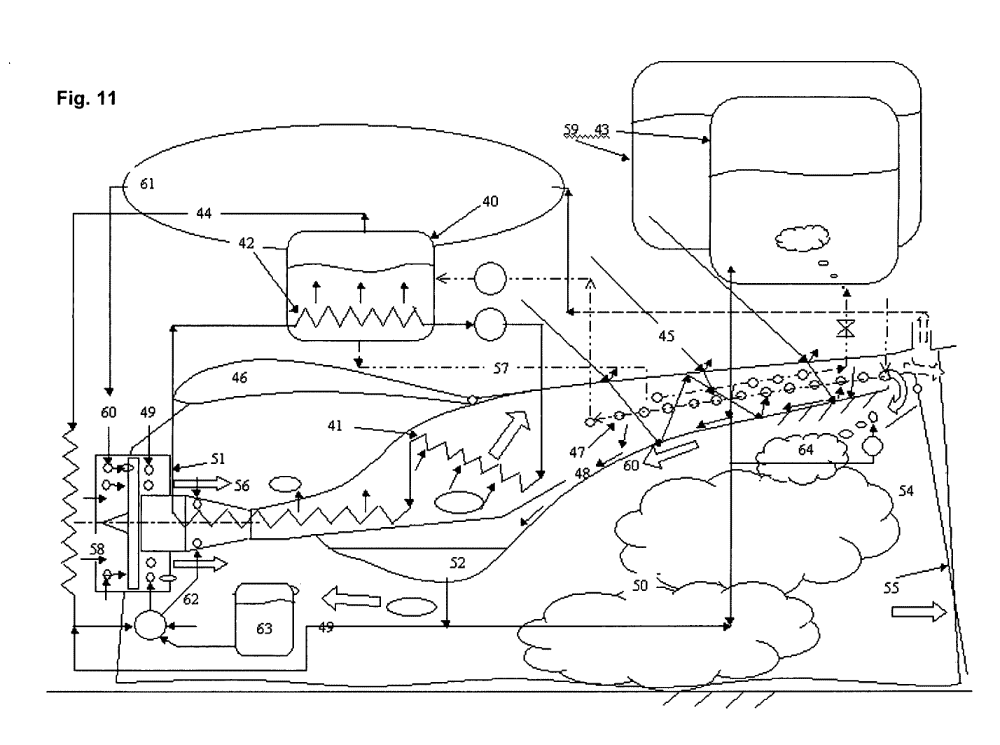

FIG. 11 shows the multi-role aircraft in sectional elevation view with evaporative distillation seawater desalination processing in schematic form.

Referring to FIG. 6; the catamaran hull footprint 20 contains the skirted hover cushion 26 maintained between the two splayed tails 21 25 spanned by a sheet forming a tail fin 22 with an downward-inclined trailing edge aileron skirt 24 containing the foam. This is described as the trailing edge extended wing spanned hover cushion top. This regulates hover cushion leakage aft and thereby forward and reverse movement in hover. Advantageously, the foam resists cushion dispersal under the skirting in ambient air, making it able to lift heavier loads in hover.

The hover foam cushion is also maintained by means of a centrally-mounted ducted fan 23 drawing air from above the aircraft's blimps and ducting it into the central cavity 26 trapped above the foam belt blanket between the splayed hull tails and beneath said tail fin. Flexible skirting 27 is shown with dispensed sprinkled foam blanket trail 28 forming one white ice wall surface laid strip of said virtual estuary.

Referring to FIG. 7; the multi-role aircraft comprising docking airships with rigid bi-hulls 30 with foamed CO2 gas cargoes 33 is shown laying said white ice wall foam belts width-ways from the rear of spanned hull cushions trailing edge skirted tailgate flap 32, travelling over ground 35 with the airship facing into a headwind 33 maintaining position and powered by auxiliary bow thrusters 31.

Migrating permafrost isotherm 30 is shown being protected by foam as laid in belts over and or to either side of it as described providing solar cover. Tailgate flap pivot pivoting said trailing edge aileron skirt may be extended on outriggers to contain a tail fin boom or water/surfactant conduit similar to a crop sprayer with a pumped array of water jets to lay a wider belt of foam for example 500 M wide over the cushion using blown re-mixed engine exhaust and airship-supplied CO2.

Referring to FIG. 8; the Boeing 747 recycled commercial turbojet aircraft is shown to scale in longitudinal section mounted between one of two wingtip Hindenburg-sized airships with the trailing edge extended wing spanned hover cushion top 40 and skirt 41. Downward-inclined trailing edge aileron skirt 22 extends from spanned lateral tail fin and cushion top forming a large surface area collector for condensed jet contrail water and solar heat. Table 1 shows lift, cargo and capacity calculations.

Said multi-role aircraft is capable of heavier than air ultra-low speed jet-powered raised alpha flight of 10 m/s in calm weather for laying belts over mixed terrain in addition to deploying them in raised hover with said trailing edge extended wing spanned hover cushion top providing low-speed aerodynamic lift.

Referring to FIG. 9; Airship 62 docks with cushion-sled 63. Said docking cushion-sled comprises a hovercraft with fresh water tank 70 supplying ducted fan impeller with desalinated or fresh water for blowing foams comprising a vertically-mounted ducted fan and or a turbofan jet engine 64, capable of producing and blowing foams in its outer cooler ducted turbulent bypass exhaust fan air flume 66.

Said multi-role aircraft so equipped lays white ice-wall said foams in belts, in float and sled-assisted hover 67 over all terrain at cushion height 68 and raised cushion height over terrain shown dashed 68 and on said sleds with reduced drag for carrying greater water loads according to line of sight and lie of the land over combinations of terrain to include plains, seas, lakes, slush, swamp, desertification, forest fires, fire brakes and shrub 69, ice pack ice, snow, mountain ridges, valleys, estuary banks and tundra with a raised hover and low-speed lift assisted flight height i.e. at flight speeds of 10 kph and over. Desalination unit 71 may comprise an evaporative distillate system for processing seawater as described drawn from the sea 72 into a separate sea water tank 65 for re-processing into fresh water as shown or alternatively fresh water may be pumped or scooped on board for direct use without requiring desalination.

Multiple multi-role aircraft so equipped form a fleet of aircraft to cover the 10,000s of km foam belt-laying required on a daily basis at various latitudes globally during each polar summer. Two or more multi-role aircraft as described may be also be joined to form a train with for example four or more docked airships which may be further integrated to increase belt-laying width, range and water tank sizes as described. Refer to Table 1.

Said multi-role aircraft fleet so equipped is capable of transporting polar fuel gases on their inward bound supply flights and carbon dioxide sequestrated or captured waste gases on their outward bound flights to the poles from power stations for example, thereby providing said airline and energy company carbon-offsetting modus operandi, extended to providing recycling older decommissioned less fuel-efficient jet aircraft.

Referring to FIG. 10; a sectional plan view as a development of the sectional elevation of FIG. 8, a conventional reusable heavier-than-air twin or four-engine commercial re-cycled aircraft forming the airships gondola 1 has mounted on it's extended wingtips 2 3 twin docking airship hulls 4 5. These are mounted on load-bearing girders struts spans and spars 7 8 9. Ties 14 15 complete the stable harnessed commercial surplus commercial aircraft and blimp said multi-role aircrafts main structure, providing said upper trailing edge extended cushion top surface 16 and is rigid, ribbed and load bearing to support said heavy water cargo. This rigid but flexible light structure extends where opportune inside the rigid docking airships and or fixed blimps backbones, uniting with transverse cruciform bulkheads 21. These bulkheads are fitted with radial ties or carbon fibre webbing thereby preventing gasbag fore-aft surges within the blimps as is known in the prior art. Said top spanned surface is also transparent to admit solar rays and act as a solar heat trap. The blimps internal bulkheads contain multiple compartments filled with gasbags of CO2 17 and methane 18 cargoes and lift gas 19 in various combinations depending on the aircraft flight role. Advantageously said gas bags containing mixtures of methane and helium lift gas prevent their contents from exploding during lightning strikes 20.

Advantageously, the commercial aircraft is surplus to flight requirements with an airframe nearing the end of its operational life for example, but complete with avionics flight taxiing fuel and engine management and propulsion systems. Additional water and or other cargoes including passengers containers surfactants fuels seawater and perishables are stored in the conventional aircraft's fuselage and in the rear-mounted auxiliary compartment 10 providing load balancing.

Vertical centrally-mounted engine pod comprising a ducted turbo fan engine 11 provides cushion lift in raised hover and has it's central hot exhaust flume shown dashed 12, ducted aftward and cooled by said heat exchanger primary circuit and vectored away from the ground and forest to prevent leaf cover and canopy scorching or, in the case of foam laying over ice sheets, boiling and melting.

Horizontally mounted peripheral engine pod comprising one or more ducted turbo fan engines 12 provides vectored thrust to control airship attitude.

The hover cushion is contained by the skirted 22 blimps underneath the spanned 15 extended trailing edge wing surface 16 is shown hatched. Said hatching also represents solar seawater pre-heating surface area as described. Cushion top ducting said hot engine exhaust air over said pre-heating surface area and heat exchangers is shown dashed. Tail-plane 23 forms the semi-closed skirt, which provides forward propulsion whilst maintaining the hover cushion. Engine exhaust heat exchangers are shown in section 24 25 through their manifolds also in dashed outline.

Referring to FIG. 11; steam boiler 40 boils solar heated sea water 42 with a pumped re-circulating recirculating fluid medium to include liquid sodium in a heat exchanger circuit shown in continuous arrowed lines, recovering the jet engines hot exhaust and casing heat 41. This forms the primary circuit. Fresh water tank 59 provides additional alternative larger cool fresh water store for direct mixing with surfactant store 53 with a capacity of about 1% total water volume to produce turbofan-blown foams. Said salt water will not foam or provide effective land greening unless the salt is removed as in this example by evaporative distillation. Afterburners reduce exhaust gas temperature and improve gas mass reactance for thrust are provided by cool fresh water injectors 62. Seawater 43 can be desalinated and pumped back into said fresh water tank as fresh water 59.

Steam 44 is cooled by a second heat exchanger circuit 58 in the engines turbofan inlet where it condenses, and is combined with cooled fresh water and metered surfactant and condensed recovered exhaust moisture to make foam. Solar heating radiator panel 45 absorbs solar heat, pre-heating the seawater 43 from around freezing in the Polar Regions to around 50 degrees Celsius, and from 30 degrees in the tropical regions to around 80 degrees. The secondary circuit also recycles hot boiler concentrated salt water and heat 57, shown chained and double dashed. The cooled engine exhaust containing primarily CO2 and nitrogen is ducted back into said docked airship 61 via arrows, to supply forward thrust 62, cushion lift, re-mixed into blown foams 65 or alternatively ducted under said cushion top to the turbofan inlet periphery 60 where it is re-mixed with ducted fan air into cool foam. Alternative exhaust CO2 flow paths are shown as dashed block arrows (right) dependent on trailing said tail plane flap angle 63, Additional docked airship-supplied CO2 is also added here peripherally 60 from 61 also behind said turbofan thus avoiding being drawn into the jet engines central compressor air stream.

For a 13,000 T seawater tank 43 spraying continuously for twenty-six hours at a rate of 500 Tonnes/hour of desalinated seawater for laying foam banks over land, the solar heating requirement would be +50 degrees Celsius/0.1389 Tonnes/second sea water pumped from said store through a horizontal solar collector area of 60,000 square metres 45, approximately equal to the area spanned between two lengthened Hindenburg airships lying 200 Metres apart in parallel extending from the rear of the central jet aircrafts wings 46, forming a catamaran hovercraft as described.

Given solar warming of 1000 Watts/sq Metre of the solar collector, this approximates to 60 MW solar heating, accounting for a significant proportion of the engine heat otherwise required for given seawater solar pre-heating through said 50 deg C and its subsequent rapid evaporation rate as superheated steam. Skirted cushion 50 is replenished and thrust at rear by pivoting tailgate 55 by directed airflow flow 54 and 56.

Said solar radiator comprises an array of long black plastic tubing 47 shown in section with a combined pumped flow capacity of 0.1389 Tonnes seawater per second required in the direction of the arrows with this forming the secondary thermal circuit shown chained and double dashed.

The boiler 40 is thus supplied with re-circulating solar pre-heated hot water where it is then brought to boil by said recovered engine heat.

Condensed engine exhaust steam condenses as water droplets on the inclined spanned reflective surface 48 which is reflective and cooled from the cooler turbofan-blown 51 re-circulating air exhaust and foam-driven hover cushion below. Said desalinated cooled water is collected 52 and pumped 49 to the turbofan mixed with surfactant 63 to blow air and foams 50 which also cover or encapsulate exhaust CO2.

The solar collector deploys a thermally transparent outer skin creating a warming greenhouse effect over said reflective inner skin to warm the sea water as described, whilst also acting as a condenser and collector for the expanded cooling exhaust gasses ducted within it. The device may alternatively be used to provide remote fresh water irrigation and forest fire fighting in hover without deploying foam.

To lay a 300M wide 0.01M deep 5% v.v. foam carpet as described in Table 1, from 0.1389 T water (0.1389 M3*20=277.8M3/sec foam volume referring to Table 1 below), the laying speed would be almost 1 M/s, or 3.6 km/h, giving a range on a water tank of 26*3.6=93.6 km. For a foam-laying speed of 10 m/s, the 13,000 Tonne water tank would exhaust in 2.6 hours. Running said larger multi-role aircraft for 13 hours on desalinated water with a further 52,000 T fresh water tank at 10 m/s=10 times water and foam output rate and in 300M wide belts as described and required, would require the craft to be 5 times larger, giving a more acceptable belt-laying range of 5×93.6=468 km.

To lay 500 m wide belts as proposed from an extended width tailgate crop-sprayer like extended boom foam pivot array with airship and engine-exhaust-blown and pumped CO2 foams from an extended wing span nozzle array or boom as with said crop sprayer aircraft as described in FIG. 4 would reduce the range to 468*0.6=280 km.

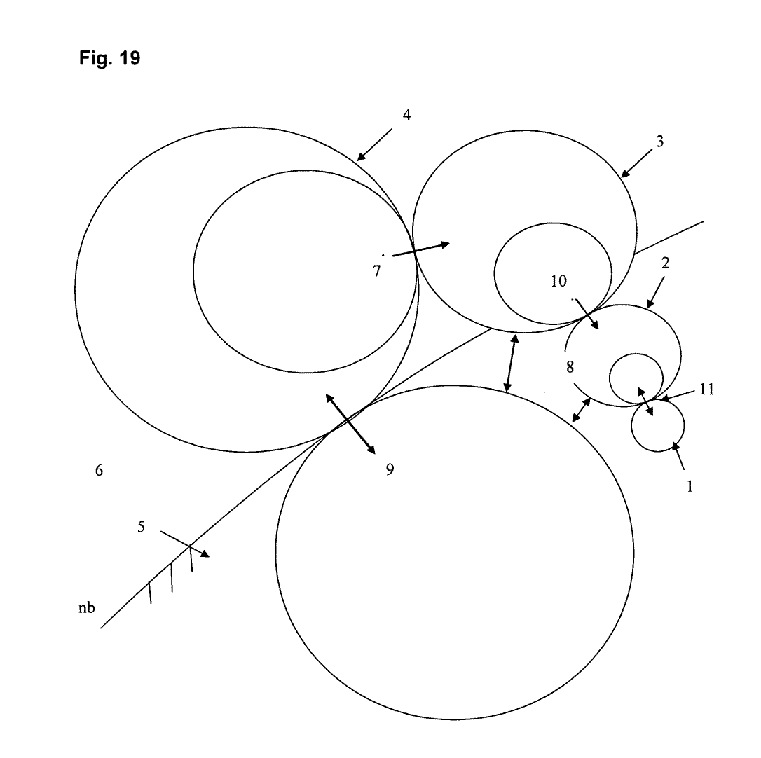

This would allow the device advantageously to source fresh unsalted water from inland lakes and or saltwater from seas and estuaries en route, stowed in a separate tank 59 as described. Laying foams over CO2 pockets of exhaust and carbon-captured gases as described to trap the gas over the ground is shown and described in FIG. 19.

Referring to Table 1, this shows the multi-role aircraft fleet sizing and load carrying capacity calculations required to achieve a near match to the Figures when laying one complete polar latitudinal foam belt at 70 deg N in North pole summer and then at 70 deg S in Antarctica in summer there, but during our winter. The solar collectors surface area and hover cushion footprint is also assumed to be larger to lay a single 500 M wide, 1 cm deep foam strip in one shot.

Advantageously, said aircraft may also be diverted en-route to the poles combat forest fires laying foam belts over canopy forming fire brakes.

The Invention will now be described with reference to Section 3

Propellant System

This invention relates to a high-level propellant system for power generation for use as a replacement for kerosene aviation fuel aircraft and deployment along virtual estuaries.

The propellant system features a wet burning, rapidly precipitating, multi-stage, air-breathing, variable-geometry fuel and oxidant, suited for use in commercial aviation turbofan jets and other thermodynamic power and impulse generation systems for reduced CO2 emissions and climate control.

Civil aviation fuels producing high-altitude CO2 emissions pose the greatest challenge to preventing global warming and reversing climate change. To meet the latest international CO2 emissions reduction targets of 50% by 2050, the improvements over conventional aviation fuel emissions as described herein offer some key potential benefits of any of the known preventative CO2 emissions-reducing emissions measures meet these targets and thereby control atmospheric warming.

A multiple-redundant array of stable wet and dry-burning, variable-geometry civil aviation fuels, oxidant stores, mixtures, sorbers and substrates, derived preferentially but not exclusively from waste, alcohols and fuel oils, is deployed variably in strategic locations altitudes sequences and speeds to increase cloud cover, promote rapid natural and contrail-assisted precipitation along a re-circulating virtual cold air estuary.

Advantageously, said propellant also provides reduced CO2 emissions at raised altitudes, also facilitating Ozone Layer repletion whilst providing maximum thrust for take-off and climb by conventional means.

Combining commercial and global climate change reduction objectives is seen as advantageous when the propellant system is deployed as described, which may lead to reduced climate change. There are several ways that these objectives can be achieved:

improving aircraft flight and fuel efficiency, reducing CO2 flight emissions, emissions trading, regulating commercial flight and deploying airships for bulk people and cargo transportation. These measures cannot in isolation halt or reverse climate change however, but the further measures and flight strategies in combination as described herein can and may do.

In the state of the art, anhydrous or concentrated butanol aviation fuel running in a fuel-efficient Boeing 787 aircraft fitted with the newer fuel-efficient turbojet engines is an example of improved flight and fuel efficiency in the forms a desirable interim goal of progressively cutting CO2 flight emissions by up to 25%; i.e. to 75% of projected 2009 levels using conventional fuels and current aircraft as an emissions base mark.

A Boeing 747-8 Intercontinental however also cuts said emissions by up to 15% through improved aircraft flight and fuel efficiency running on conventional fuel with re-designed wings and engines. With 275 passengers, 3 L kerosene per 100 passenger km consumption is achievable over a long haul 10,000 km flight requiring 82.5 Tonnes Kerosene as claimed*. The above measures also however do not on their own provide sufficiently large reductions in high altitude CO2 emissions to halt climate change.

More radical measures for achieving greater high-altitude CO2 emissions cuts include switching to airships for bulk cargo and people transportation, forming a further longer term solution for cutting high altitude CO2 flight emissions to just 20% of 2006 levels using conventional aviation fuels for replacement bulk transportation with butanol for land, sea and air. In addition, switching to higher speed ramjet propulsion for higher altitude flight using the aviation fuel as described is also proposed.

In the prior art, bio-alcohols and bio-diesel fuels are however often derived from felling the CO2-reducing rain forests to obtain for example palm oil, which defeats the objective of creating a market for the carbon-trading with bio-mass. Fuels derived from biomass waste on the other hand do not deplete natural resources or compete with food crops and methanol for example is a readily available by-product of existing industrial processes. Anaerobic digesters also produce methanol with carbon dioxide and methane in biogas and this fuel-from-waste stream can also be used to make it into fuel mixtures including the higher alcohols.

The heavy as air airship option however facilitates slower transportation. A substitute wet-burning aviation fuel with lowered high altitude CO2 emissions that rapidly-precipitate-out night facilitating solar blocking and land breathing, suitable for use in current and future heavier-than-air flight that has minimum environmental impact is required and described. Vapour trails of condensed exhaust are well known as jet contrails in the prior art and they are produced at high altitude by commercial turbofan jet aircraft as combustion products condensing into the cold air along with invisible carbon dioxide. Hydrogen peroxide and readily available methanol and the other alcohols used as liquid fuel-oxidants and therefore wet-burning fuels are also known and deployed in air-breathing hybrid rockets including the infamous German V2.

Such moisture-laden exhausts have significantly improved gas mass reactance and water is also used in said turbojet engines exhaust expansion chambers as after-burners to cool the exhaust gases before they char the airships thin skin fabric and boost thrust and moisture. Propellant mixtures are known to create intense white and potentially toxic exhaust flumes however, making them less stealthy and more problematic to deploy especially in and around busy civil airports as civil aircraft fuels where high visibility has been retained a safety requirement. This safety requirement is no longer overriding as instrument flight and GPS now predominate in today's congested airspace both on the ground and in the air. Propulsion and fuel systems have also traditionally been single-stage; divided into turbofan jets with lower specific impulse and lower specific consumption, running on standardised kerosene fuel mono-propellant (as air breathers) and rockets running on other liquid (and solid) propellant mixtures with additional oxidants with higher specific impulse and consumption across all flight speeds. By carrying oxidants however, the rocket incurs a weight penalty and so becomes limited in range compared with the turbofan jet and limited to high-speed operation above the main atmosphere, requiring a higher specific thrust. Liquid fuels are preferred over solid propellants especially for their controllability and ease of dispensing potentially in civil aviation, but wet-burning aviation liquid alcohol fuels and kerosene can freeze when exposed to high altitudes over prolonged periods and in space. The more toxic liquid hydrazine fuel-oxidant propellant is then the preferred choice.

Any effects that more moist exhaust emissions may have on significantly improving cloud formation during daylight and contrail precipitation (facilitating overnight planetary surface heat breathing radiating heat through the atmosphere into space) will have to be cumulative over repeated flights and combined global polar flight strategies to enhance cloud formation and increase daytime solar blocking cover, which are also described.

Deploying a virtual cold air estuary below the flight path and laying moist exhaust trail night-breathing day-blockers within and above it will also be described.

A virtual estuary behaves like a real one thermally and so can include a rain forest, mountain ridges, valleys, real estuaries, coast lines, cliffs, snow lines, ice sheet banks and or combinations of the above with man-made foam belts laid in parallel to channel sink air providing rapid overnight contrail precipitation to the ground below.

A requirement exists to provide a turbofan jet civil aviation fuel that emits lower CO2 levels when cruising high altitudes to reduce global warming whilst retaining comparable specific impulse and thrust, operating range and altitude capability in cruise, take-off and climb. Steam-producing, wet-burning fuels (including kerosene) provide optimal gas mass reactance and hence thrust, whilst carrying water as ‘dead ballast’ decreases a fuel stores calorific value and hence aircraft payload, increasing store size requirements. Kerosene emits a lot of carbon dioxide for a given specific thrust. However, concentrated hydrogen peroxide stored as ‘active ballast’ reduces this burden.

Requirements also exist for producing water-laden cloud-seeding especially for supplying isotherm-threatened warming ground with cloud cover, dwindling forestation threatened with desertification and or warming and or remote land-locked areas of drought.

This requirement is broadened to include aerial deployment over any terrain requiring rain cloud seeding for irrigation, over deserts, desert greening, fragmenting polar ice sheets, coast lines, tree lines, valleys, great planes, crops, soil erosion, rain forests, forming tornados hurricanes and typhoons and in the path of Westerlies, Roaring Forties, The Jet Stream, The Gulf Air Stream, over oceans, The Arctic Circle, The Antarctic Circle, The Tropic of Cancer, The Tropic of Capricorn, in winds and estuaries with climactic air streams overhead of man-made virtual and or natural origin and according to lie-of-land.

There is also a further central requirement for the fuel to be simple to deploy i.e. it has to have a stable ‘single-shot’ dispensing and automatic direct-from-tank delivery method and not be dependent on complex pumping mechanics and dual fuel-oxidant transport logistics, making fuel-oxidant rockets prone to mechanical systems failure and be therefore too risky and heavy for practical civil commercial use on mass.

Fuels are however currently stowed in multiple inter-pumped stores and distributed about an aircraft to trim the aircraft's centre of gravity.

Rocket and missile fuels have in the prior art comprised separate tanks for holding different propellants and oxidants for different flight modes and stages. In commercial aviation, a single ‘one size fits all’ fuel mono-propellant, namely kerosene has remained the predominant fuel of choice, with the alcohols for example butanol (Virgin Fuels) just recently beginning to make an inroad into the market.

There is a particular fuel-oxidant propellant known in the prior art however comprising methanol and liquid hydrogen peroxide which offers favourable low CO2, minimal toxicity, high moisture emissions.

For current commercial aviation, the requirement for a re-usable aircraft with high reliability, low specific fuel consumption, air-breathing turbofan engines and a universally standardised mono-propellant namely kerosene drives the design

For efficient future commercial aviation as well as ground-to-space flight, the requirement for a low-weight, reusable versatile reliable aircraft with single-stage engines and multi-stage propellants drives the design, running ideally on a mixture of fuel propellants, air and oxidants that vary according to flight speed, location, deployment sequence and altitude.

The fuel-oxidants main requirements will now be summarised:

Speed Requirement
At conventional sub-sonic turbofan jet flight speeds between about MACH 0.2 and 0.9, kerosene (carbon chain length 12) and the slower-burning butanol-based aviation fuels are best suited.
Kerosene already produces moist contrails but high levels of CO2 emissions accompany these.
Advantageously, wet-burning fuels (including kerosene) produce enhanced reflective ground cover during the daytime when deployed routinely in high alpha flight and at take-off, increasing the ground precipitation from vapour emissions.
In RAM mode at supersonic flight speeds between about MACH 1.0 and 2.4, alcohols hexane and hydrogen peroxide are suited ‘wet burning’ propellants.
In SCRAM mode at mach 2.5 and above in hypersonic flight, the fuel requires to be faster-burning with a flame speed of 1,000 to 1,500 m/sec and this is suited to mixtures of hydrogen and methane in air-burning engines, rather than alcohol and kerosene. The shorter chain-length aliphatics however volatile and a non-volatile fuel is the preferred safety option for sub-sonic commercial aviation flight using turbofan jet aircraft.

Location Requirement
Flying over and along a polar virtual cold air estuary is the preferred aviation propellant deployment option over flying Great Circle routes. This can be beneficial, especially if laid by routinized polar flight paths within the cloud base over cold ground, valleys, mountains, airports, forest or snow or between belts of surface whitening within and around the Arctic and Antarctic regions as described. Minimised CO2 emissions over hot deserts and at high altitudes above cloud base are required to reduce global warming.

Altitude Requirement
The atmosphere is more tolerant of and the ground more able to absorb the heavier moisture-laden carbon dioxide exhaust emissions especially from low-altitude flight. At low altitudes from take-off up to and including cloud base, the emissions of carbon dioxide and water vapour make less of an impact on the environment and conventional proven kerosene fuel provides this essential ‘kick-start’, clearing airports and cities essentially. At raised altitudes, having climbed above about 1,500 Metres however, a wet-burning fuel mixture comprising additional hydrogen peroxide and alcohols including for example methanol held in an array of stores and or combined in stable gels for mixing is advantageous for further climbing to a cruising height of about 10,000 to 15,000 Metres. Above 15,000 Metres and MACH 1, the fuel needs to be faster burning ultimately with a lower octane shorter-chain and the fuel mixture requires to be hydrogen and methane-based with the hydrogen peroxide oxidant also added. There is an overlap with the higher altitude and speed requirements. Since most of the fuel load is required for take-off and climb to cruising altitude, the alcohol fuel blends deployed at altitude will not require greatly enlarged tanks.

Deployment Sequence Requirement in Conventional Turbojet Aircraft—the Multi-Stage, Traffic Light Fuel Cocktail:
at take-off and climb to cloud cover with a full payload, a high specific thrust is required, followed by a lowered CO2 emissions exhaust to cruise above cloud cover. As the aircraft reaches its polar corridor, a wet-burning moisture laden exhaust deployment is required as described.

One of the main problems of alcohols is the trade-off between their low calorific value, increased availability compared to fuel oils, lower cost and ability to carry or store oxygen ‘chemically’ rather than being cryogenically cooled in special steel stores. Alcohol fuels however burn more completely and cleanly at higher altitudes in thinner air than kerosene for a given flight speed, especially if they are augmented with hydrogen peroxide, but they burn more slowly and deliver less specific thrust. But again at raised altitudes, there is less drag resistance making faster flight more economical and thereby improving range or economy. Reduced CO2 emissions achieved by fuels emitting reduced CO2 high altitude flight are thought to have a significantly reduced effect on the greenhouse gases affecting global warming.

According to the present invention there is provided a high level civil aviation propellant system with a Russian doll sorber that generates rapidly precipitating reduced CO2 emission moist dense white solar reflective jet contrails comprising:

wet-burning rapidly-precipitating multi-stage air-breathing variable geometry flame speed kinetics fuel mixtures and oxidants, a multiple-redundant array of stores, tri- and other numbers of states, gelled emulsions of product-propellant mixtures, aliphatic fluids, waste derived alcohols, a water moderator with dissolved oxidant, collapsible walled stores, rigid pressurised stores, in-engine propellant mixing, a traffic light fuel cocktail containing an in-store fuel mixture, fixed collapsing store sponge substrates, pumpable Russian doll sorbers, a means of combining varying replacing and boosting thrust, a means of enhancing cloud-cover, a means of location speed sequence and altitude-based variable deployment, a means of reduced CO2 emissions production at high altitude and a means of Ozone Layer repletion.

The Invention will now be described in two embodiments in which fuel propellant mixtures are stored firstly in separated stores and secondly in combined fuel stores, both with a separate optional oxidant propellant store:

### First Embodiment

In the First Embodiment of the Invention, The aviation propellant system has an array of multiply-redundant specialised fuel and oxidant stores wherein each said fuel array member operates as a semi-autonomous fuel source, able to provide engine thrust in air-breathing flight, especially for ground-avoidance manoeuvring at low altitudes, but it is configured to deploy at maximum efficiency in a given flight mode as described, dependent upon location, speed and altitude.

By means of example:—the lack of availability of any of the multiply redundant oxidant stores to all of the engines will not prevent the aircraft from reaching higher altitude air-breathing flight flying on all engines, but it will be incapable of sustaining higher altitude flight, requiring then to fly on ‘wet burning’ alcohol fuel emulsion blends as the given available non-redundant store exhausts as described.

By means of a further example:—at least one multiply redundant oxidant store and one multiply redundant fuel store are required for full power ground-avoidance manoeuvres and aircraft operation under all flight modes flying on all engines, whereas just the remaining low-octane fuel alone is required to be functional for an emergency landing only under controlled powered glide landing approach.

The individual fuel-oxidant stores will now be described chemically:

Alcohol fuels are also complimented at high altitude by hydrogen peroxide fuel-oxidants as is known in the prior art, with both combustion ingredients being highly miscible in water, which acts as a moderator. The molar equation for wet-burning methanol and hydrogen peroxide produces cleaner specific thrust comparable with kerosene, thereby requiring less oxygen and producing reduced CO2 emissions in the thinner air below:

| Ingredients | -> | Products | |
|---|---|---|---|
| O₂ + H₂O + CH₃OH + H₂O₂ | -> | CO₂ + 3M.H₂O | (1) |
| 18.5M.O₂ + C₁₂H₂₆ | -> | 12M.CO₂ + 13M.H₂O | (2) |
| 6M.O₂ + C₄H₉OH | -> | 4M.CO₂ + 5M.H₂O | (3) |
| 25M.O₂ + C₁₂H₂₆ + C₂H₅OH + H₂O + | -> | 16M.CO₂ + 20M.H₂O | (4) |
| C₂H₆ | | | |

The gel sorbers and particulate suspensions have been omitted to simplify the above.

From the above molar analysis, 84 g ‘wet’ methanol fuel (1) including hydrogen peroxide fuel-oxidant propellant mixture burns cleanly in air to produce 44 g carbon dioxide therefore and

170 g ‘dry’ kerosene fuel buns cleanly in air to produce 528 g carbon dioxide (2) and 74 g ‘dry’ butanol fuel burns cleanly in air to produce 176 g carbon dioxide (3).

The wet traffic light fuel cocktail mixture is also shown (4) for comparison.

The ethane gas ingredient reduces the flash point of the wet mixture sufficiently to ignite it and or to enable it to foam safely on rapid decompression following leakage or tank rupture, and the fuel mixture can be thus used in transition as a continuously variable ingredient mixture when exiting from climb role to cruise role producing dense white exhaust flumes when flying over virtual estuaries areas threatened with drought, thawing, desertification and or rain forests as described. Alternative gas solutes include methane, propane, and butane in order of increasing solubility in the kerosene component. With fuel gas solutes added to form volatile fuel mixtures in ‘Russian doll’ containment, the pressurised tank embodiment is required with rigid tanks.

It can also be seen from (1) that adding dilute peroxide oxidant from an autonomous store array member reduces the CO2 whilst boosting water emissions to augment thrust at high altitudes as described, also acting as a moderator to control combustion rates. Therefore the proposed 168 g wet fuel-oxidant (closely matching the fuel weight for weight of kerosene) produces just 88 g carbon dioxide (1), one-sixth of the amount of conventional aviation fuel. Reduced CO2 emissions were however not the original ‘design driver’ behind the decision to relegate these fuels to unmanned and missile applications and they have remained along with solid fuels the ‘Cinderella Fuel’ with W.W.2 and infamous German V.2 rocket connotations.

Similarly with butanol, 2.3M (170.2 g) produces 404.8 g carbon dioxide, which is a reduction of 23.3% in carbon dioxide emissions, compared with aviation kerosene by weight.

The fuel store still requires to be larger however because of the lowered calorific value of methanol and the higher alcohols to a lesser extent, but this can be augmented with said hydrogen peroxide store and additionally longer carbon chain particulates including flour and coal dust in low molar concentrations for burning at lower altitudes as described. Additionally, sorbed aliphatic fuel gases added will also boost the fuels CV and economy will also be further boosted by flying higher, raising the altitude ceiling to 20,000 Metres or more for a conventional turbofan jet aircraft.

Second Embodiment comprising one or more volatile pressurised rigid walled stores:

In the Second Embodiment of the Invention, mixing two of the fuels above as described above in equal measure to make an aerosol fuel ‘product’ by weight and gasifying the mixture with gas ‘propellant’ as shown below, the variable geometry product-propellant aviation fuel ‘traffic light cocktail’ pressurised store is obtained (referring also to equation (4) above). The varying geometry fuel mixtures and water moderator provide variable flame speed kinetics and thrust optimised by proportional mixing in-store for deployment at given altitudes, latitudes and flight phases to include take-off, climb and cruise and flight speed with the addition of a further oxidant deployed from an autonomous store and pipeline-pumped in-engine injector system.

By emulsifying, gelling and gasifying the wet fuel mixture with hydrogen in Russian Doll sorbers, along with additional methane, ethane and or 1 pg being added as their partial pressures in storage at pressure are lower, it becomes combustible in conventional jet engines and the flame speed is thereby moderated by the water content present:

n.ηP+4.H₂+3.O₂+H₂O+CH₃OH+H₂O₂→CO₂+8.H₂O

The above by molar weights where 1.ηP represents the nano-particulate volume and hence size of one coal dust or other particulate in gel suspension to include flour, metal coated high BET surface area sorbers hydrogen sorber and n represents the number of nano-particulates required to sorb 8 g of tunnelled H2 (and other gases including methane) through the gel-fluids contiguous up-structured suspension medium.

Similarly with pentanol, hexanol and each of the other alcohol series members in-between methanol, making up a viscosity match. Advantageously, synthetic alcogels comprising metal organic frameworks (MOFs) are tolerant of high concentrations of short-chain alcohols (and solved gases including methane, hydrogen, ethane, 1 pg) without decomposing, unlike longer chain natural gels, and form the basis for ‘Russian doll’ sorber ‘nano’ scale molecular containment as described in the priority document, held within the ‘micro/macro’ flocked sponge substrate containment in emulsion with natural gels in suspension. Further to the above, blends of aliphatic oils oils gases and alcohols sorbed in a sponge substrate as described, comprising a gelled emulsion of MOFS, coal dust and other particulates and natural gels compliment the ‘Russian doll sorber’ fuel as described in the priority document, enabling smaller hydrogen, methanae and ethane aliphatic gases to ‘tunnel’ through the gel into the particulates for optimum sorbing under pressure over several hours and chilled as described in the priority document.

In addition, the complimentary oxidant store containing non-volatile concentrated aqueous H2O2 solution in flocked sponge substrate can however be collapsible and non-pressurised as described in the second embodiment.

Second Embodiment comprising or more, collapsible walled stores:

In the second embodiment, suitable for deploying in current commercial aircraft and turbofan jet engines, the fuel is built up as a traffic light cocktail with a hydrophobic head and a hydrophilic tail dispensed and deployed ‘top-down’ from the fuel store without using gases which will be compatible for use with existing turbojet aircraft, with the butane partially solved in the tail, partially in the head and partially in itself.

The invention will now be described with reference to the following figures:

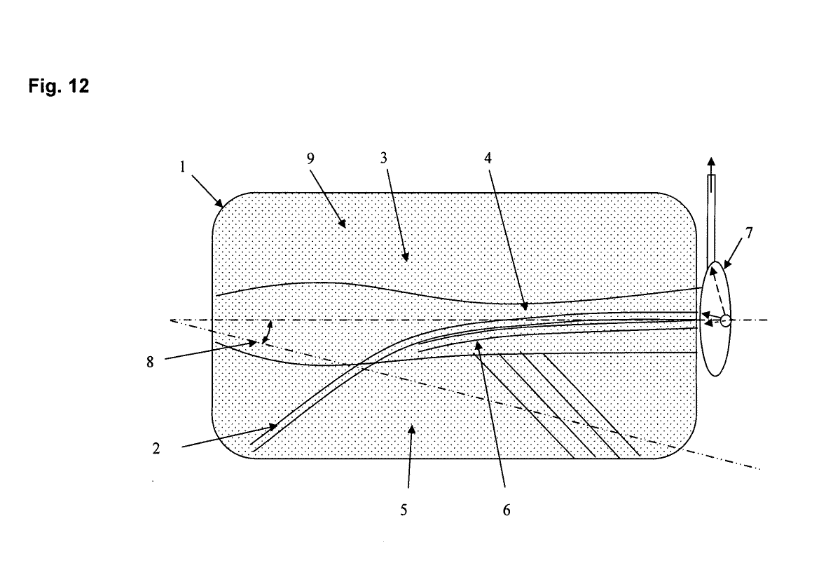

FIG. 12 shows the gasified ‘bottom-up’ traffic light high-speed variable geometry traffic light volatile fuel store cocktail tri-state in the high-speed Second Embodiment of the Invention with in-store fuel mixing,

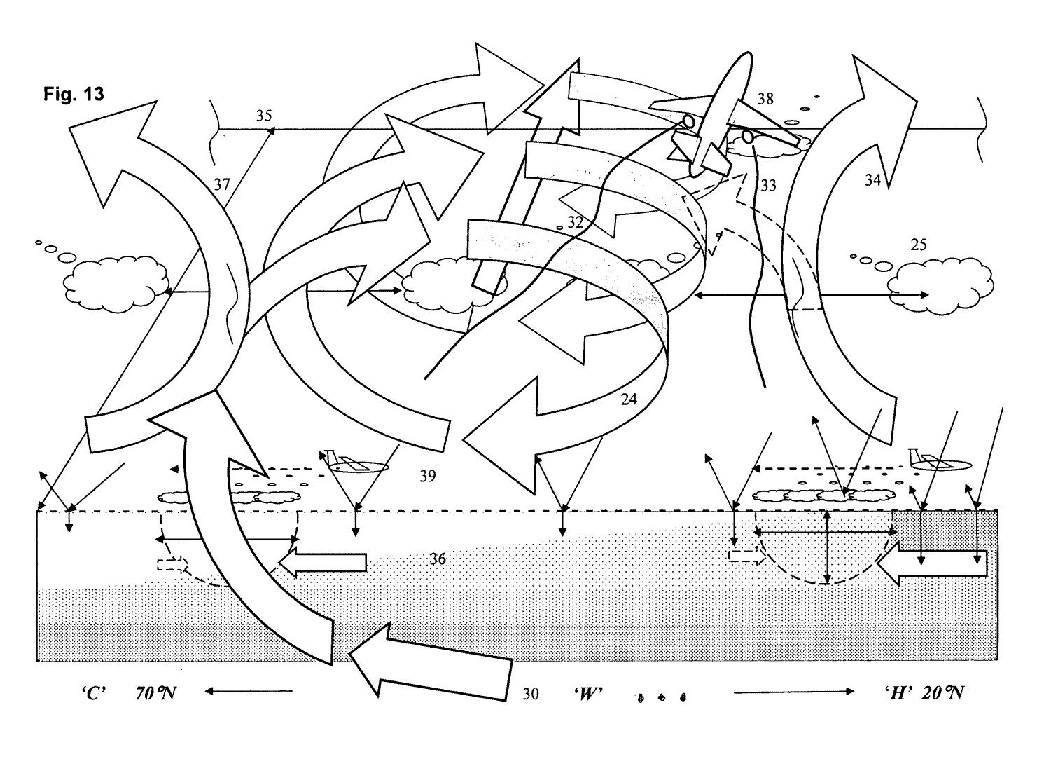

FIG. 13 shows the wet burning, rapidly precipitating aviation propellant deployment along a virtual cold air estuary thermal corridor in either Embodiment of the Invention. This deployment can also apply to existing aviation fuels namely kerosene, travelling at lower speeds and altitudes in climb below cloud base,

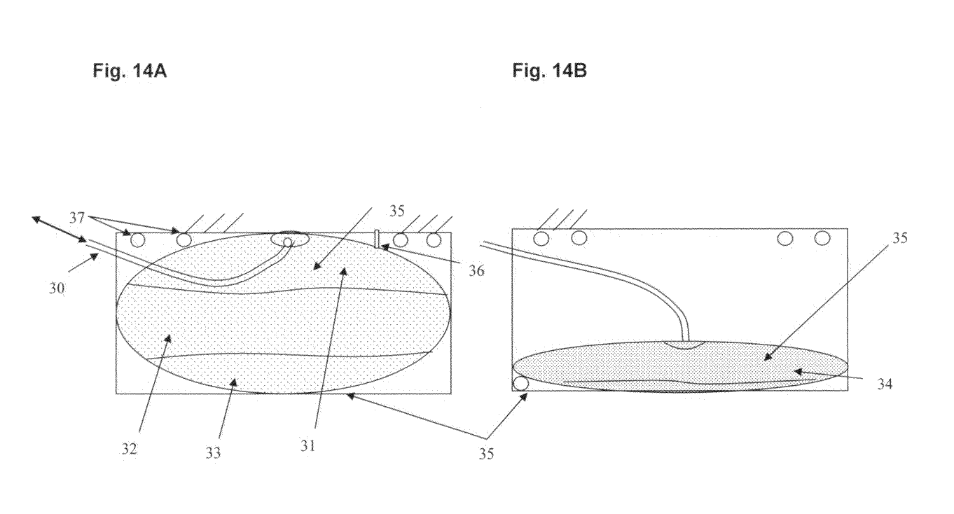

FIG. 14 shows the ‘top-down’ traffic light middle speed variable geometry fuel cocktail deployment from a single collapsible walled store

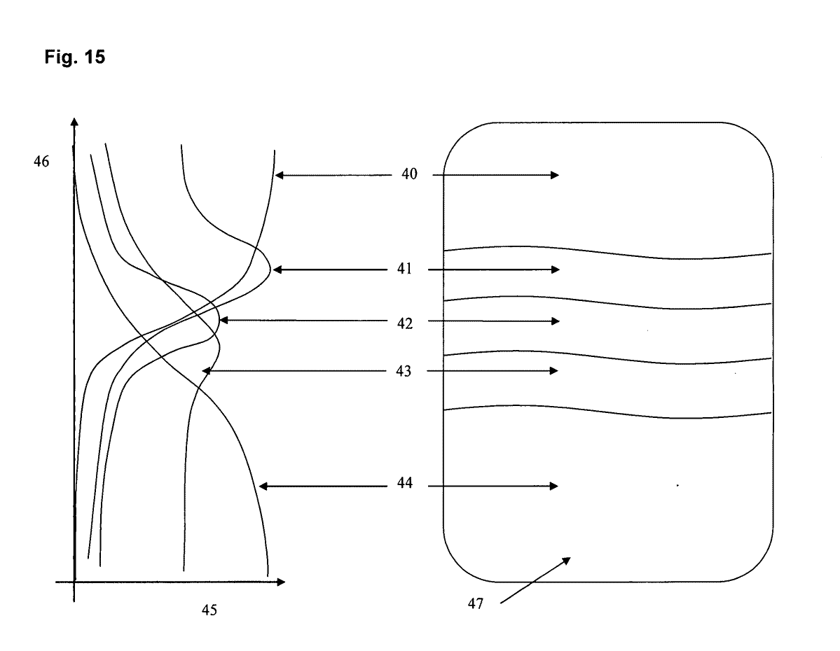

FIG. 15 shows the rigid-walled store with location-specific miscibility fuel stack components in the second embodiment in sectional elevation.

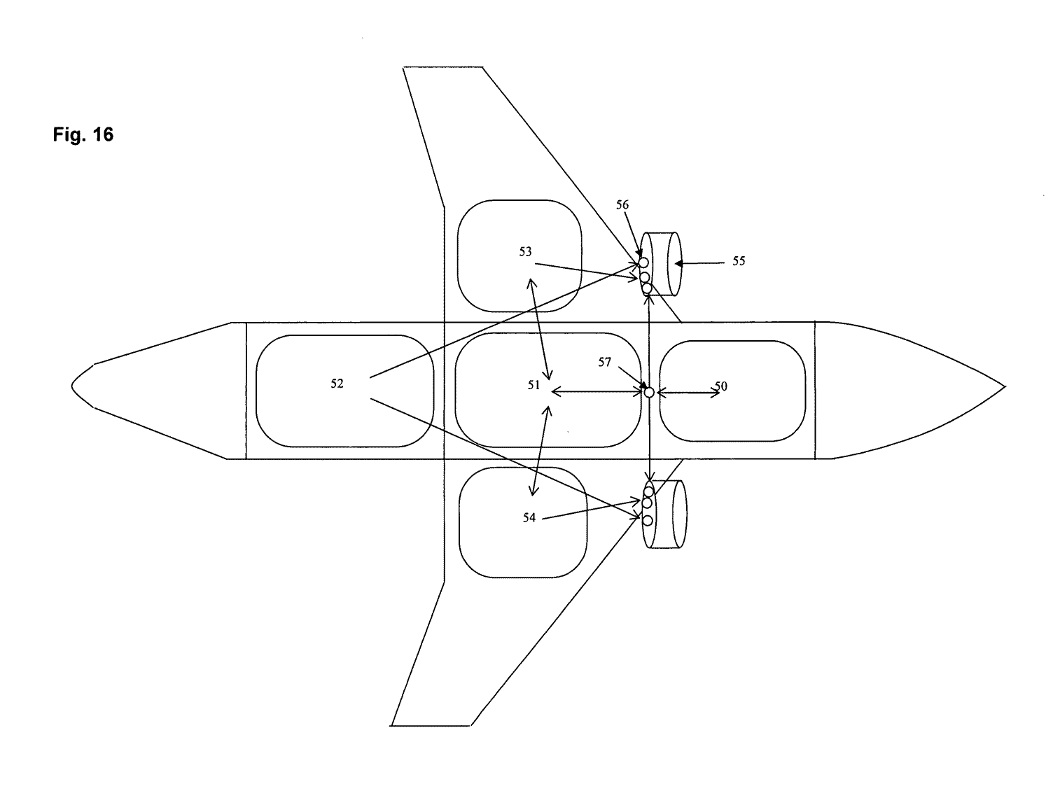

FIG. 16 shows in schematic form the operational overview the multiple-redundant array of un-mixed stable gels tri-states and emulsions of aviation mono-propellants derived from wastes alcohols fuel oils water and oxidants stored and deployed separately in collapsible stores prior to just-in-time, safe in-engine or in fuel-line mixing.

Referring to FIG. 12, the ‘traffic light’ fuel cocktail is shown in its aerosol store with aliphatic gas propellant-pressurised tri-state liquids and gel products in the first embodiment. The fuel is shown mixed and settled into its tri-state in rigid-walled pressurised said store 1, as it is drawn off ‘bottom-up’ through lower feeder tube 2.

Mixing is obtained by chilling, pressurising and agitation internally or externally, and by also adding a capillary acting sponge and product-propellant sorber to prevent fuel tank slewing, rapid bubble-seeding sloshing and mixing shown dotted 9, surfactants and a natural or synthetic gelling agent to set the fuel oil emulsion, a stable fuel cocktail is created that settles into a stable tri-state or other number of states in the store as shown with the gas propellant 3, with the liquid gas propellant component 4, partially solved in the kerosene product and finally the ‘wet’ alcohol base product settled at the bottom shown hashed 5. The addition of the viscous gel components increases the alcohols surface wetting property and said different settled stable states facilitate differential sorbing of individual propellant gases. Advantageously, the tank is made from low-weight composite materials and the wet fuel foams on tank rupture, reducing its flammability, an important safety feature.

As the aircraft takes off and climbs at raised alpha flight 8 to cloud base, most of the lower wet product is run-off through the feeder tube, thereby lifting the payload with maximum gas mass reactance achieved from the moist exhaust thrust, strategically located at the back end of the store to preferentially collect the lower tri-state product. The aircraft then climbs above cloud base after using-up the fuel-oil shorter chain aliphatic hydrocarbons including the partially oil-solved propellant gases within the next tri-state level, climbing at a higher speed and with lower alpha. It eventually reaches its cruising altitude of 15,000 or more, rather than about 10,000 metres, the current trend. At this altitude, the aircraft is levelled-off and running primarily on the switched compressed fuel gases and optional residual methanol and hydrogen peroxide where it produces less carbon dioxide emissions as described and travels faster.

The second feeder tube 6 is switched to allow selective hydrogen peroxide and methanol mixture supply in high altitude cruising and for landing to boost thrust on demand. As the second propellant runs out, just switched gases remain available through the upper feeder tube, facilitating a brief firing of the SCRAM jet flight mode for steep climbing to sub-orbital flight. The fuel is compatible with conventional turbo-jet civil passenger aircraft and if used routinely will reduce the effects of high-altitude CO2 exhaust emissions on global warming. Pressure regulator diaphragm valve 7 acts in a conventional way as with domestic fuel gas cylinder pressure regulators and supplies the fuel line and engines with a safe regulated flow of product-propellant fuel, requiring minimal pumping to the engines injectors. This fuel store is not suitable for operation in very high extremes of altitude thermally un-shielded for protracted periods of flight where the ambient store temperature falls below −40 deg. C for many hours. Switching failures 7 are error-critical and this represents the weakest safety point of the fuel system.

In addition, all intercontinental flights in the Northern Hemisphere are routed in a low polar flight corridor, following the Arctic Circle, North of the snow line and South of the Polar Ice Sheet between other ground-based belts surface whitening placed along the migrating permafrost isotherms to create cloud seeding and convey moisture overland within a virtual cold air estuary thermal corridor.

Said product propellant sorber—substrate comprises an alcogel metal oxide framework hydrophilic product or emulsion of products including sorbed volatile gases held in an open-celled flock-foam forming a ‘Russian doll’ substrate and sorber-in-sorber, including emulsive suspensions of coal particulates.

Referring to FIG. 13, the virtual cold air estuary thermal corridor is shown located underneath the global latitude-following flight-path 20 with commercial aircraft 21 flying long it deploying wet-burning fuels within the cloud-base to impart moisture into the circulating air system to enhance the cloud cover. Said estuary may comprise a rain forest, and area of drought-threatened desertification or the Gulf or other air streams and jet contrails 22 comprise rapidly-precipitating propellant system with solar blockers providing both visible and invisible thermal from water vapour and CO2 emissions respectively. Said virtual estuary comprises in this example man-made foam laid bank breather-blockers 23 24 to provide diurnal sink air currents aiding contrail and natural airborne moisture precipitation, which may be substituted or complimented by natural features including mountain ridges, snow lines, rain forests, cliffs, coast lines, ice sheet banks and or valleys.

Referring to FIG. 14; the second embodiment of the invention is described with top-down fuel-oxidant feeder tube 30.

The fuel-oxidant tank is shown collapsible, elastic walled and filled with a soft open-celled foam sponge flock sorber located within its substrate 31. Advantageously, such collapsible fuel tanks are deployed in existing high performance military aircraft to prevent build up of fumes and to enhance fuel delivery through aircraft manoeuvres especially during inverted and high alpha flight.

Fuel Tank Refuelling

The fuel cocktail is introduced into the evacuated tank bottom first but top down through the fuel feeder tube, beginning with a metered chilled quantity of gelled concentrated alcohol in aqueous solution. This is followed by a further metered quantity of the blended aliphatic oils including chilled butane*, hexane, octane, decane, duodecane and kerosene. Then the blended emulsified alcohols are added last. * In the elastic walled collapsing store tank, overpressure bladder and breather valve expansion for butane boil-off will be required when the refuelled aircraft is left standing on the hot tarmac for extended periods with the engines are shut down. The more volatile aliphatic fuel fractions require therefore ‘just in time’ refuelling, overpressure breathers and ideally holding tank refrigeration, as determined by airport logistics.

The fuel traffic light is initially mixed by turbulence in the expanding sponge substrate and it then settles out to form tri-state layers under gravity comprising an hydrophobic oily head, an alcohol-concentrated body and a hydrophilic tail. Said longer-chain alcohol members octanol are slightly more miscible in the upper oil layer especially in the butane and hexane, with the shorter member butanol (optionally) remaining partially miscible in the water and alcohol blend-containing tail. The presence of butane in the tri-state increases the butanols solving in the oily layer. Both specific gravity and specific miscibility of the blended alcohol mixtures determine the geometry of the fuel store with the longer chain members resting above the shorter chain members.

The order of fuel component refuelling and its chilling to 0 deg C prevents flammability danger and improves the gentle sponge mixing, with the concentrated alcohol blend trickle-mixing through the partially sorbing oily layer before making contact with the settled tail. By evacuating the fuel tank fully prior to aircraft refuelling, the refill is kept relatively rapid, complete, fully metered and automated.

Fuel Tank Deployment

The fuel is drawn off via said feeder tube by the engines fuel pumps and the aircraft is free to undertake normal extremes of manoeuvring within and beyond existing commercial aircraft flight envelopes.

In a large commercial aircraft, sustained inverted and high-alpha flight is not encountered, but if such conditions were to occur and then sustained over a minute or more, the engines would not stall but run on the changed fuel tri-state, producing less desirable environmental effects e.g. white smoke flumes providing a graphic warning of the onset of some partial loss of thrust. Under such conditions, normal flight could however be recovered. Over several minutes, the gelled fuel tri-state would be configured to gradually re-align itself with gravity through the sponge sorber.

A further feeder tube is added to access the fuel ‘bottom up’ in the event of tank rupture and or for residual fuel access for landing approach and this also allows its partial pumping into a spare tank.

Advantageously, the flexing tank's sponge can be made from auxetic foam and the tank walls can be made semi-rigid dual lined and self-resealing to prevent the effect of leaks causing loss of fuel availability. In the event of catastrophic tank rupture, the sponge retains the gelled fuel emulsion in situ' by capillary action and its metallic coating can conduct heat and sparks, with said oxidant tank or tanks requiring non-volatile, non-metallic surface coatings. Advantageously also, this second embodiment of the invention allows the variable-geometry fuel to be drawn off in the order required; mainly kerosene at take-off for maximum thrust and low-altitude based low climb to cloud base, mainly butanol/kerosene mix above cloud base and mainly peroxide/butanol mix for location and altitude-based deployment over the polar corridor or desert as described for wet-burning, lowered CO2 emissions.

Referring to FIG. 14A; one propellant store array member is shown in different stages of sequential deployment. The tank is shown in its three quarters-full, expanded state during the early stages of a flight primarily in climb with each tri-state present; 31 kerosene, 32 upper alcohol, 33 alcogel in water solution. The upper kerosene-containing tri-state is partially run-off through feeder tube 30. The tank sponge 36 is shown partially expanded as dots in section through the tank.

The aircraft wing tank is shown filling a chamber in said wing section of constant volume represented by the outer rectangle 35. Overpressure breather valve 36 is shown to allow evaporative boil-off, and the alternative in-tank chamber refrigeration radiator is also shown 37 with tank chamber upper surface insulation.

Referring to FIG. 14B; the fuel tank is shown in its one-quarter full semi-contracted state running primarily on butanol just prior to running on its butanol fuel state 34 during the early stages of polar flight approaching the thermal corridor. The tank sorber sponge 35 is shown partially compressed.

Referring to FIG. 15; the second embodiment shows the specific miscibility and specific thrust 45 curves plotted and leveraged by specific gravity 46, according to settled tri-state location in store 47 shown upright for the non-volatile deployment of butanol in a continuously-variable geometry traffic light cocktail. Butanol 41 is placed in the middle and is leveraged for its dual miscibility both in blended oils 40 and water 44 along with itself and the other alcohols in the middle including propanol, pentanol, septanol, octanol 42 and decanol 43 according to carbon chain length. The longer the alcohols' chain lengths, the mess miscible they become in water, hence more miscible in said oil blend to including the shorter-chain blended aliphatics including hexane. Since the ‘tri-state’ traffic light cocktail comprises blended oils, alcohols and water-loving components in a stack, the settled state layers containing emulsions gels and mixtures thereof are not clear-cut, but fuzzy with each leveraging each adjacent members miscibility as described.

One or more of said settled tri-states may comprise a Russian doll sorber for absorbing particular propellant gases, suited to its deployment speed and altitude requirement as described.

Referring to FIG. 16; four multiple-redundant propellant store members and one oxidant store member comprise the propellant systems store array 50, 51, 52, 53, 54. Said array members may comprise collapsible flexible and or pressurised rigid member tanks containing individual deployment location and altitude-specific fuel mixtures, with one or more oxidant and or water moderator ingredient mixture mixing in-engine for selective deployment facilitating just in time mixing as described. The propellant store array is shown in a typical symbolic aircraft store display layout form, connected for inter-pumping propellant mixtures to turbofan aero engine 55 supplied with separated autonomous fuel and oxidant lines feeding multi-point injectors 56 for just in time in-engine combustion chamber mixing, shown by arrows and in-pipeline pump mixing 57.

By burning said resulting fuel oxidant mixtures in cruise ‘fuel-weak’ and ‘oxidant-rich’ at high altitudes, ozone-rich exhaust flume jet contrails are obtained. Advantageously this allows the additional higher altitude location-based repletion of the Ozone Layer to be performed in cruise over multiple repeated commercial flights.

Fourth Section:—The Airline and Energy Company Modus Operandi for Carbon-Offsetting Commercial Flights Energy Generation and Polar Mining Activities

This invention relates to a means of promoting carbon capturing and offsetting anthropogenic CO2 emissions through the issuance of carbon credits for carbon trading, forming a commercial modus operandi for airlines and energy companies.

Carbon trading with carbon credits has not hitherto provided a means of preventing polar ice cap melting, desert greening, rainforest preservation or increased storm severity, especially with regard to carbon capture technology and providing incentives to airlines and energy companies to participate. In addition, the environmental cost of high-level carbon emissions has not been resolved for commercial flight sufficiently to allow carbon trading to occur with passenger air miles. High altitude flight has hitherto been thought desirable from the perspective of passenger comfort. Flying above the turbulence meant that cruising altitudes of 10,000M had to be sustained. At this altitude however, the CO2 present in jet contrails does not dissipate rapidly overnight in thermals and sinks as they are emitted above the weather systems present in the lower layer of the troposphere by definition, referring to FIGS. 2 and 3. In order to earn carbon credits to promote greener commercial aviation development, a low CO2, rapidly precipitating aviation fuel is required and described that can be deployed at altitudes of 10,000M and above cloud base in a location-based airline modus operandi as described, whilst not discouraging the advantageous use of conventional propellants at lower altitudes.

According to the present invention there is provided:

A carbon credit trading system providing means of promoting carbon capture and offsetting forming a commercial location-based modus operandi for airlines and for energy companies based on redeemable public-private micro-credits.

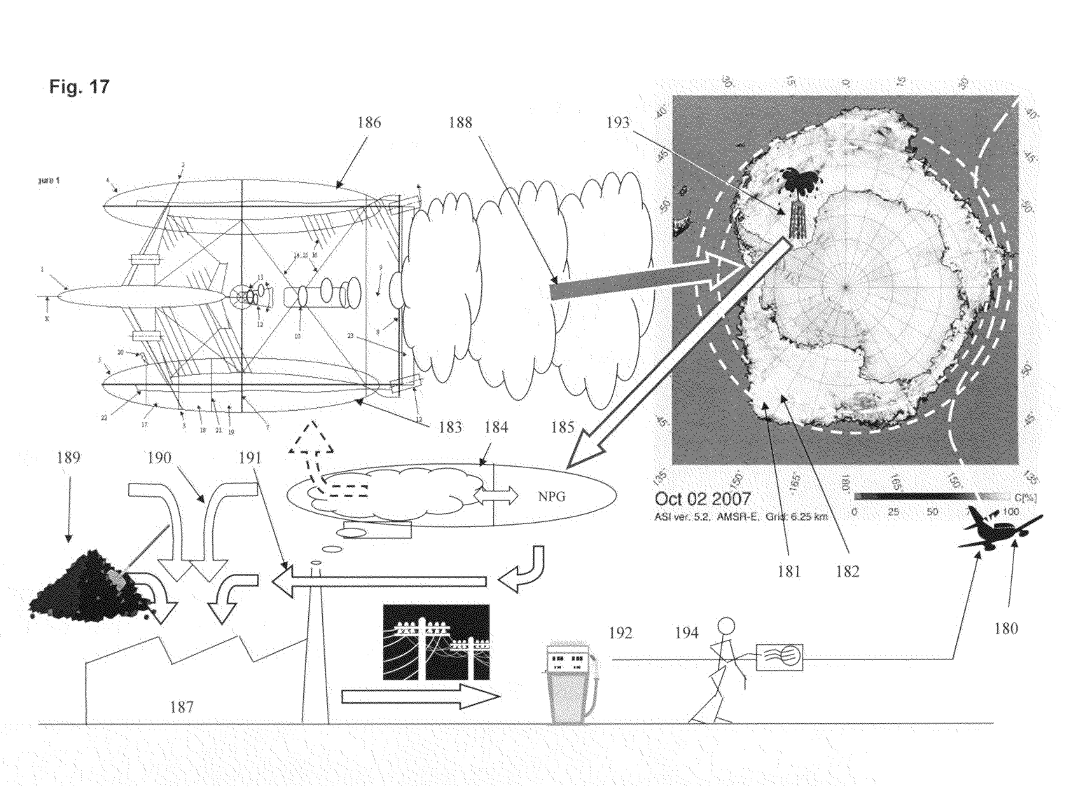

The invention will now be described with reference to FIGS. 5 and 17:

FIG. 5 shows the airline global flight routing Polar Modus Operendi

FIG. 17 Shows The combined airline and energy company Carbon-offsetting location-based Polar Modus Operandi.

Referring to FIG. 5; a jet contrail blocker produced by burning aviation fuels and propellants comprising kerosene and or a fuel mixture producing dense white jet contrails in commercial aircraft is flown frequently over said virtual estuary devices to include rain forests with their flight routes adopted where commercially practicable from great circle-following routes 66 68 67. Flying along and between said virtual estuaries forming bounded thermal cold air corridors forming and containing climate streams at given latitudes, operation is limited to daylight deployment as described 59.

Referring to FIG. 17; said modus operandi may also be used by energy companies requiring especially to offset mining in the polar regions for oil gas and mineral production extraction 193 processing and consumption producing energy for example in power stations 187 by preserving the polar coastlines from melting and causing rising sea levels 181 182. Commercial aircraft 180 have their frequent polar flight paths diverted to follow a high latitudinal polar planet ring comprising two virtual estuaries 181 182 at 65 and 70 deg South. Fuel gas especially Polar Methane 191 is transported to said power stations as mined from the poles 185 directly by airship and/or said Multi-Role Aircraft MRAC 184. Said airship and/or MRAC then collects captured CO2 from the power station and returns to the South and or North Pole 188.

Energy Company Location-Based Modus Operandi

Said airships and/or MRAC's then dock with multi-role aircraft 186 having collected a large load of sea or fresh water or ice as described and deposit CO2 in foams forming said white ice walls of said virtual estuaries. Refer to Table 1 for foam volumes and foam laying requirements and airship fleet capacity calculations. Advantageously, said power station can burn coal 189 oil and or biomass 190 without requiring alternative carbon capture technology with blimp and pressurised CO2 storage prior to pick up by airship. The processed fuel obtained from fuel pump 192 may contain a pumpable substrate comprising said Russian doll sorber substrate which can advantageously be used to pump powdered coal 189 in nano-particulate suspensions gasified with Methane and Hydrogen for burning in said aviation propellant system as described and also in said power station for electricity generation.

Said fuel and power station has in effect a multi-sourced cleaner and greener coal and fuel mixture burning and processing capability. The inner ring shown dashed comprising said planet ring of two virtual estuaries forms said ice walls late summer 70 deg South fall-back position for the fragmenting polar pack ice and ice shelves, able to preserve the poles permanently frozen core year-on-year to prevent polar melting as described in Section 1.

Carbon Credit Trading System

Carbon credits are redeemed by airlines for public air passenger miles flown whilst deploying said wet-burning fuels in flights diverted along said virtual estuaries and to energy companies for airship-captured CO2 by mass delivered and offset at the poles, over forests which are redeemed privately as described. Examples of said carbon-offset polar flights include:

London-Calgary-Vancouver-Beijing (flying 65 deg North ring) and Auckland-Cape Town-Anchorage-Buenos Aires (flying 65 deg South ring).

An exchange-trading rate per passenger-estuary-mile flown on said propellant system is agreed and fixed against annual target levels, redeemable by airlines on a regular basis. An exchange trading rate of carbon credits issued per M3 CO2 captured by airships primarily from power stations which are successfully transported to and storage offset as foams laid in polar locations as described is agreed.

Credits may also be issued on a per MWh electricity generated basis from polar mined and sourced methane gas and local coal with carbon capture-offsetting as foams in forests and virtual estuaries as described by energy companies is agreed and fixed against annual target rates, redeemable by energy companies on a regular basis.

The invention will now be further described by means of two examples:

In the first example, the carbon credit trading system comprises credits of a transferable currency with a mark-up to include broadened accumulated passenger air miles or Java beans for example and an accounting system allowing commercial energy airline and other companies governments or enterprises to earn accumulate and redeem credits to offset against tax for example by flying along prescribed routes altitudes and fuels at prescribed times as described. The number of kilometres or miles flown per passenger whilst deploying said wet burning low CO2 propellants as described in summer daylight flights, along and above said virtual estuaries as described, earn said credits of 0.01 US Dollars or one bean per passenger air mile 194.

In comparison with the above, the number of kilometres or miles flown per passenger whilst deploying conventional kerosene fuel in summer night time deduct 0.01 US Dollars or one bean from their accumulated air miles credit. Flying conventional fuels along prescribed routes at prescribed times and seasons are neutral. The extra distance flown diverted from great circle-following flights to fly at prescribed latitudes as described also earn 0.01 US Dollars or one bean per extra KM flown.

The carbon credit also has a virtual estuary belt laying mark-up for energy and other companies exploiting Polar resources which is earned by the successful deployment of CO2 carbon capture by mass or by volume in airships gas holders or blimps at power stations. For each successfully transferred Tonne laid as foam belts with a prescribed water content at various prescribed latitudes and according to lie of land along said virtual estuaries and greening as described, 1.0 US Dollars or ten beans are earned per Tonne of CO2 captured and 1.0 US Dollars or ten beans are earned for each kilometre of said foam belts successfully laid as described.

Referring to Table 1, two giant airships would therefore each earn $513.78/2 per captured CO2 emissions cargo by mass per polar trip and 57,770 trips would earn $14,840,530 p.a. and 1,111 airships docking with said multi-role aircraft fleet would earn a further $29,680,380 p.a. successfully laying one continuous equivalent 302,200 kM latitudinal foam ring belt 10 times p.a. as described, given an exchange rate of 1 cent per bean of micro-credit.

Additionally, each Tonne of airship captured methane Polar fuel gas successfully transferred by said airships back to said power stations on its return journey would earn $1.0 credits or ten beans (you don't want to lose this gas in transit as it is hazardous to the Ozone layer and storing it near ntp mixed with lift gas and CO2 reduces the environmental consequences of accidents and leakage.

The revenue for this commercial return-for-profit cargo justifies the economic outlay for said foam offsetting climate processor. The annual natural polar gas supply from 57,770 trips will be in the region of 57,000×100 Tonnes CH4 gas by mass, giving a value added tax deductable annual revenue of a further $5,777,000.

Section 5: Tunnelling Russian Doll Sorber

The present invention relates to a decouplable level physical and molecular level gas sorber with a contiguous and a non-contiguous up-structure deployed in a volatile fuel mixture to provide a means of holding supersaturated gases in liquid solutions and in semi-solid gel gel-emulsion suspensions in stable foam physical substrates forming tunnelling “Russian Doll” containment.

A molecular level sorbed contiguous up-structure can comprise for example a series of consecutive aliphatic members sorbed progressively into each other in order f increasing carbon chain length (and hence decreasing volatility).

The solubility of methane gas in petroleum oil is limited and proportional to its pressure and decreases with raised temperature, to about 8.2% by mass in 5000 psig at 50 degrees Celsius. Butane is highly soluble in Hexane by comparison with Methane in petroleum oil and hence hexadecane with a 70% molar sorbing ratio. Similarly, propane is highly soluble in liquid butane giving liquid petroleum gas LPG under moderate pressures at room temperature. Acetone is also known to be a good sorber for acetylene and coal powder for hydrogen and carbon dioxide gases; similarly metallic powders can absorb hydrogen gas under pressure. Surface coating catalytic sorber effects of fine metallic powders suspended in emulsions are also known, producing high BET surface areas.

At the molecular level, macromolecules such as denatured proteins are known to form gels in suspensions and solutions with the solution filling inter and intra-molecular spaces. These structures can be described as non-contiguous. Because of the large molecular size inherent in the gel solution and suspension, the effects of supersaturated gas pockets forming micro bubbles from within the solution is limited, creating a kind of structural semi-solid gel fluid tear resistance ‘wall-to-wall’ through their container, comparable to micro crack and tear formation-resistance in load-bearing solids and composite materials.

At the physical level, there has hitherto not been a method of uniting the physical substrate with the molecular substrate into a contiguous up-structure by order of size.

Micro-celled ‘flocked’ natural sponges are known to have superior fluid sorbing properties in the prior art.

Organic compounds are also known to solve into non-organic compounds and vice versa, obeying the general rule of smaller solving into larger within similar bonding structures i.e. ionic or covalent but occasionally crossing bonding eg. Haeme the building block of red blood cells.

In the prior art, natural gas hydrate pellets NGH stored and chilled at 20 degrees centigrade were not pumpable and required to be ‘boiled off’ for the gas to be transported ashore via pipeline pumping. Additionally, NGH contains a high proportion of water by weight, making its energy density as a cargo for transportation by sea for example comparatively low.

Also in the prior art, volatile fuel fractions were separated into pure molecules by fractional distillation. This has the disadvantage of making the lower fractions more volatile with respect to the whole product, e.g. unrefined naphtha.

According to the present invention there is provided:—a decouplable physical level and molecular level gas sorber with a contiguous pumped and non-contiguous fixed up-structure deployed in a volatile fuel mixture to provide a means of holding supersaturated gases in liquid solutions and in semi-solid gel gel-emulsion suspensions forming pumpable substrates in stable foam physical fixed substrates forming tunnelling Russian doll containment. A way of providing gas sorbers with improved sorbing capacity through deploying contiguous up-structures to allow the smaller gas molecules specifically hydrogen but also methane and propane to ‘tunnel’ through the structures with encapsulation as solved into larger carrier molecules of similar type is described.

By means of example, the next higher member in the aliphatic hydrocarbon series acts as a good solute within a host liquid further up the series.

This “Russian doll tunnelling contiguous up-structure” invention will now be described by the following example:

Propane solved into hexane is solved more readily in hexadecane than propane in hexadecane alone. By then solving further hydrogen into propane, the hydrogen can be tunnelled by encapsulation within concentric intermolecular spaces through the liquid sorber to the solid particulates in suspension deeper within the fluid which form the more effective sorbers over time exposed to high pressure storage. Particulates suspended in the fuel emulsion include catalytic surface sorber porous metal powders, crystalline macro-molecular coal dust, synthetic gel structures, Buckminster Fullerenes and also giant macromolecules such as starch and flour. Advantageously, these particulates form inter and intra-molecular spaces and gel emulsion semi-solids for the sorbed gas to collect without seeding into larger pockets to form bubbles, thus resisting localised micro-bubble formation in supersaturated solution. Hydrogen as the smallest gas molecule sorbs more slowly into powdered particulate macromolecules including coal dust and red earth in suspension at high pressures. When solved initially into a liquid solute as previously described at a moderately raised pressure and lowered temperature relative to STP, the solubility of hydrogen is initially limited. Advantageously this gasified gel fuel store improves sorbing capacity with prolonged storage at raised pressure and lowered temperature whilst allowing their pumping and dispensing, giving a specific advantage over NGH whilst also allowing brief exposure to ntp during dispensing affording improved leakage tolerance and resistance over LPG.

The invention will now be described according to the Figures:

FIG. 14 shows the fixed substrate collapsible store as it is filled with pumpable substrates.

FIG. 19 shows the tunnelling Russian doll gas sorber pumpable substrate based in a natural gel colloidal molecular suspension

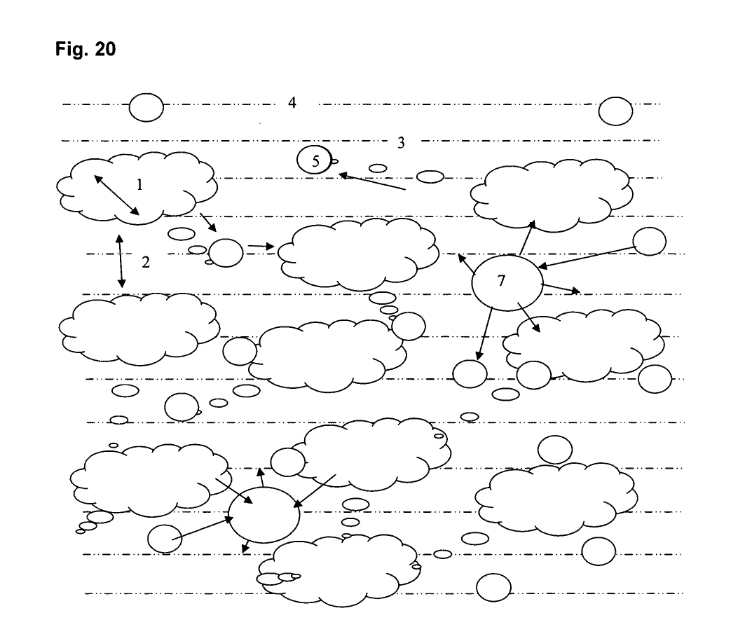

FIG. 20 shows the gas sorber in macro-molecular pumpable substrate in conceptual view based on a natural and synthetic hybrid gel colloidal molecular suspension

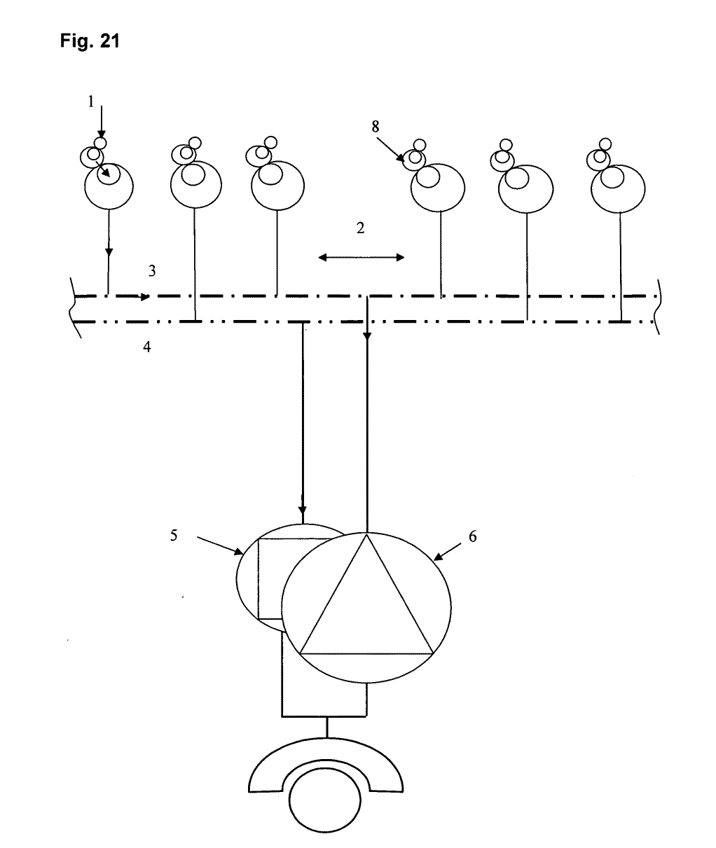

FIG. 21 shows the gas sorber structure in functional conceptual micro-macro view based on a hybrid gel colloid derived from a gel emulsion of natural and synthetic gel. bases with added particulates forming non-contiguous cross-medium contiguous sorbing tunnelling Russian doll up-structures.

Referring to FIG. 19; the Tunnelling Russian doll sorber from the nano-molecular level is shown bottom-up, with the hydrogen gas 1 molecular weight 2 first solved into the solved methane solution 2 molecular weight 16, this solution of liquid hydrogen and methane then solves into liquid propane 3 molecular weight 44 forming a further solution which then solves into the butane 4 molecular weight 58 forming a further solution which then solves into the octane 5 molecular weight 114 forming a further solution and so on. Each above-mentioned solute-solutions comprises inter-molecular spaces 6 which hold the smaller molecules solutions as vapour suspensions above the gelled liquid surface 5 by inter-molecular forces 7. Intermolecular forces 9 7 10 11 exerted by the gel bind the molecular up-structures together shown as double-ended arrows in decreasing thickness to indicate decreasing order of magnitude. Additional forces attract coalescent tails of molecules in loops back to the liquid surface to further decrease the fluid volatility 8.

Referring to FIG. 20, a natural gel with macromolecules of starch with inter-1 and intra-2 molecular spaces is shown representing the top down view of the tunnelled hydrogen. The detail shown in FIG. 1 would be too small to see in FIG. 2 and is shown separately. Wan der Waals intra and inter-molecular forces bind the molecules and gel suspension together 3. The macromolecule 1 comprises denatured protein shells or husks with their hydrophobic and hydrophilic heads and tails 3 partially exposed to water-4 and oil-5 soluble molecules forming and binding the stable colloidal molecular suspension. The macro-molecular weight and hence size 2 lies typically between 1,000 and 100,000 atomic units. Intermediate size molecular surfactant to include decanol 7 further binds the solution into the colloid suspension forming longer-chain binding intermediate size molecular inter-structures of molecular weight=158 to further prevent volatile solved supersaturated gas bubble seeding out of solution.

In a further embodiment a synthetic gel is deployed in place of the natural gel with similar inter and intra-molecular spaces as produced in a loosely packed crystalline structure in the early stages of manufacturing a SiO2 aero gel crystalline macro-structure in water. By washing out the water with concentrated ethanol, alco-gel is obtained. This is then further emulsified with binding longer-chain surfactants 10 and fuel oil 11 and then gasified under pressure 11 with hydrogen methane propane and butane solutes forming Russian doll sorbers with the alcohol and or oil as solvents and or emulsions as described above.

Advantageously, this synthetic gel can hold concentrated alcohol without precipitating out the gel and thereby avoiding destroying its stable gel up-structure.

Additionally, greater fuel batch production performance and quality control is achieved with the artificial gel base, requiring less water to lower the fuels overall calorific value CV.

Referring to FIG. 21; the fixed and pumpable substrates are shown combined in conceptual view to form a non-contiguous up-structure with cross-medium support structures comprising the fuel store.

The hybrid synthetic 3 and organic 4 gel bases are formed into and emulsion prepared by shear mixing and thus emulsified with the gels and added macromolecule particulates to include oil-coated flour 5 and coal dust 6 sorbers pre-mixed in an oil paste to provide neutral floatation buoyancy in the setting chilling gel emulsion. The hydrogen 1 is preferentially sorbed migrating shown arrowed through the macro-molecular up-structures to the solid particulates 5 6 through the multi-media over time. The surrounding fluid suspension is gelled to create reduced volatility and stable containment. The methane 8 is preferentially sorbed into the oil via the chilled viscous gel up-structure to reduce its bubble-seeding volatility. Advantageously, this structure has intermediate level inter- and intra-molecular size containment, forming a further molecular sieve making a compromise between fuel stability, production control and quality in terms of fuel viscosity volatility pumpability and storage life. The plug symbol at the bottom shows in symbolic form the gelled contiguous pumpable sorbed fuel mixture into a fixed foam substrate as a ‘plug-in’ contiguous upstructure in a replaceable modular fuel propellant store.

Referring to FIG. 14; the fixed and pumpable substrate store is shown in operational deployment where the fixed substrate comprises a foam-filled, collapsible elastic-walled tanked 34 high-level aviation propellant system as described.

Section 6: Surface Whitening System with Gel Foams Foam Beather Blocker Surface Whitening

The current invention relates to a surface whitening system for laying on the ground to prevent global warming

According to the present invention there is provided:

A range surface whitening gel foams that can be deployed in an aerosol or in a blower that acts as a thermal thermal breather-blocker suitable for applying on terrain surfaces that inflates and decays at a predetermined rates causing said surface cooling insulation shade conduction and irrigation at a pre determined rate comprising a product propellant ingredient mixture to include water.

The foam range is customisable in terms of inflation viscosity and decay which are varied by changing the relative concentrations of the water-based aerosol product ingredient mixtures and the aerosol propellant pressures. By adding CO2 and biogas to said propellants, a means of carbon offsetting and carbon storage capture location is obtained which also assists said surface cooling by evaporative decay or boil-off in the afternoon heat.

Said foam range is also customisable according to the intended application and location, ranging from heavy-weight viscous gel foams comprising slurry and nutrients with biomass biogas VOCs and a high water content of 8 to 12% v.v. for irrigation of crops and intensive greening deployed in wind onto hot surfaces for forest fire-fighting where white reflective middle-weight foams are also used similar to shaving gel and fire fighting foams with a water content of 4 to 7% v.v. to light-weight foams comprising mostly blown air similar to domestic washing and bathing foams with a low water content of 1 to 3% v.v.

Said heavy-weight foams may be off-white and slow to inflate, containing primarily CO2 and VOC rather than air propellant mixtures and be bio-active and deployed overhead or from within an artificial tree or pipelined sprinkler array. Said foam is designed fall through and be dispersed within or above a natural or artificial tree canopy which can then be overlaid by a further lighter-weight white foam as described to create an odour-free anaerobic composting blanket to kick-start sustainable breather greening and anti-desertification as described.

Said middle-weight foams strike a compromise between foam depth, range on water tank, irrigation and persistence and find use laid in the virtual estuaries said breather moisturising and greening where low-level irrigation surface whitening and moisture are required for achieving sustainability as described.

Said light-weight foams may be applied to greater depth and range on water product tanks, lending itself to being air-blown to emulate light summer snowfall, assisting with diurnal terrain belt cooling in hot climates causing minimum environmental impact to the soil and air-breathing wildlife.

Depending on the ambient surface and air temperatures, said foams may freeze in tact or collapse-out overnight into slush. If they harden their shells by freezing they become resistant to wind, achieving extended persistence especially during prolonged periods of polar daylight By varying the foam mixing and aerosol parameters including nozzle aperture, the requisite foam aerosol density range as described above is obtained empirically. The foam cell wall thickness and cell size are varied and controlled during application and mixing by said applicator nozzle aperture propellant pressure and feed rate according to the required persistence and hence rate of decay as determined by v.v. % propellant product density obtained. Said aerosol mixing may be in-store or in-nozzle with a combination of multi-point injectors for different ingredients including low pressure blown air at high aperture and high pressure CO2 at low aperture.

The invention will now be described with reference to the following Figures:

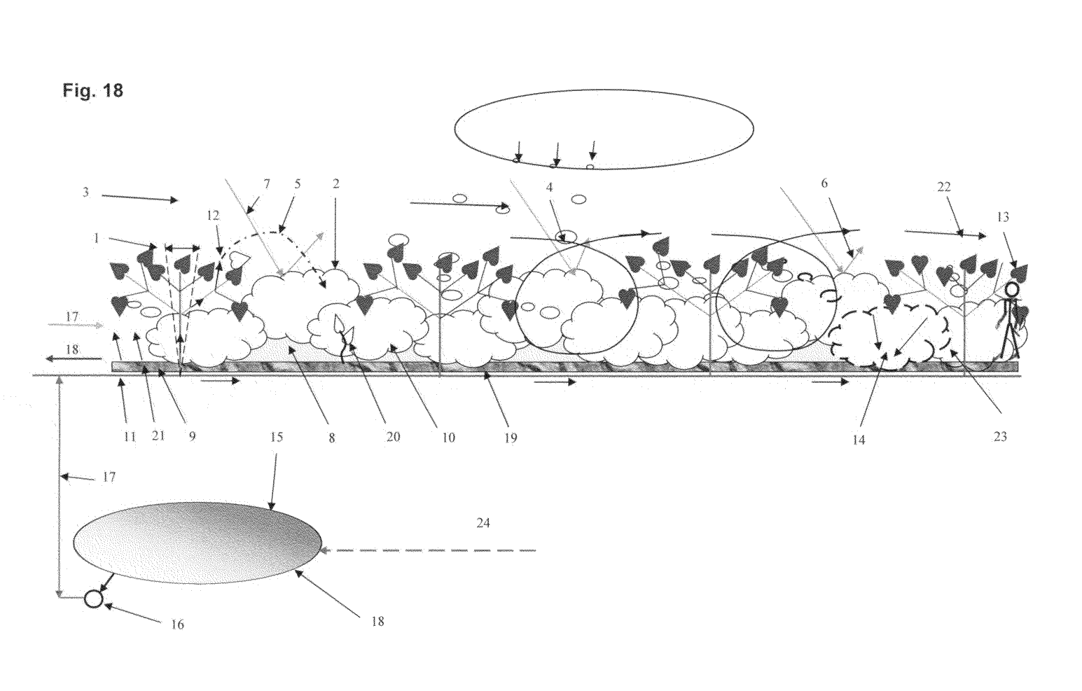

FIG. 18 shows the carbon dioxide location offsetting as foams in rain forests forests and in the greening of said virtual estuarial breathers

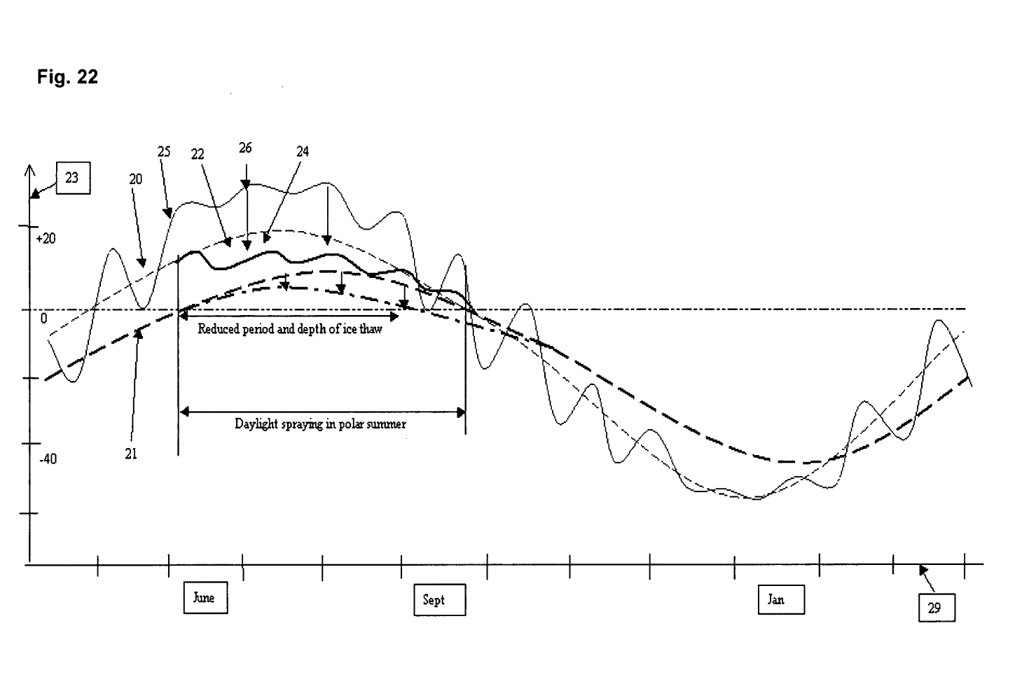

FIG. 22 shows the reduced solar warming and hence Polar cooling effect of said foam belts laid as breather blockers in Polar pack ice and ice shelfs in Polar summer over several diurnal cycles compressed into an annual temperature cycle.

Referring to FIG. 18; carbon-offsetting is also deployed by spraying CO2 and air foams in forests in temperate and tropical regions and in belts to limit forest fires and provide low-level irrigation for the greening of virtual estuaries to provide the breather with an enhanced microclimate cover to resist desertification as described.

Said foams may be bio-active and laid over rotting bio-mass forming an odour-free anaerobic composting waste digester topped with a lighter-weight odour-free foam blanket.

The odour-free CO2-water foam composting comprising slurry bio-mass or waste CO2 gasified water colloid and surfactant 9 traps sour bio-gases or inactive waste CO2 8 forming a foam carpet barrier 10 and the swaying artificial tree array 11 delivers compressed foam product-propellant via hollow insulating taproots held over ground 11 to sprinkler nozzles 12 to control and stabilise the foam. By providing solar u.V. and heat protection, CO2 emissions from collapsing foam and VOC fallout protection 10 into moderate prevailing winds especially upwind from inhabitants 13.

The artificial tree array acts as a foam aerosol swaying remote automated dispenser for controlled delivery maintenance and also collapse of the foam 14 and digester process by injecting various surfactants yeasts glucose inoculum feedstocks and surfactants through its distributing sway sprinkler jet system as described in sequence over the lifetime of the primary digestion during its noxious and odorous first week of composting. Advantageously by controlling the duration and rate of collapsing of the foam, the rate of irrigation and exposure to sunlight can be regulated by example to avoid peak sunlight exposure of young saplings during high sun 6. This moderates the semi-conducting thermal junction surface temperature as described in FIG. 1.

A low pressure blimp 15 stores the uncompressed aerosol product-propellant in a gas holder, which is then reversibly recompressed via a pump 16 for distribution via pipeline—pumping to the tree array via interconnected tap roots as described. Advantageously the self-propelling expanding product-propellant aerosol can be delivered by the interconnected tap roots up hillsides to a higher head than water alone for a given propellant pressure 17.

The aerosol comprises CO2 propellant, a water product and further water soluble products and sludge suspensions to include nutrients, glucose, slurry and a gel base 18. Typical gel foams comprise approximately 0.1% surfactant v.v. i.e. decanol soap jello starch or slurry and Visceau in even proportions depending on fine-tuning of persistence as described and 5 or 6% water and 93.9% air and or CO2 by volume. The water solution when comprising a bio-active wort containing starch and slurry is tolerant of a moderate ethanol methanol fermentate content not exceeding about 5% by mass (like a sherry trifle which increases evaporative surface cooling).

When planted interspersed with a natural forest, shelterbelt or copse, the artificial tree array dispenses CO2 in foams as described 10 which are absorbed more slowly by the ground 19 and natural greenery 20 as they progressively decay and collapse over several diurnal cycles without being blown up and evaporated in the wind 3.

When CO2-containing foam is deployed within a natural copse shelterbelt or forest, the CO2 is preserved within the microclimate for absorption by the ground and canopy.

Advantageously, irrigation by foam is made more efficient than conventional spraying with evaporation losses dramatically reduced 21. This enables the tree and foam structure to maintain humidity levels at very low levels of irrigation as supplied or made available in dwindling forests over increased range compared with conventional water sprinklers. Said foam may also be a white CO2 water foam used in fire fighting.

Firestorm Protection to limit forest fires is implemented by spraying a CO2 foam blanket over the ground from dispersed artificial tree arrays or from aircraft and airships overhead and deployed in belts or fire brakes as described which resist airborne flame propagation between tree canopies and prevent air reaching the seat of the fire downwind 3 22 23.

Referring to FIG. 22; the figure shows in simplified schematic form a graph of mean seasonal air temperature 20 shown dashed and warmed time-lagged ground temperature 21 shown dashed. The vertical temperature axis of the graph is centred at 0 deg. C 23, the freezing threshold for permafrost. Actual diurnal temperature variation 22 caused by solar warming is shown overlayed. During the late summer season, the permafrost and hence ice sheet has gradually warmed up and is then vulnerable to melting and structural failure leading to fragmenting icebergs drifting into the sea. This occurs when the ground ice and permafrost temperature exceeds the 0 degrees Celsius axis. Temperature scale units are shown not to scale in +/−20 deg. C. This data provided is fictional and shown in abstract form for demonstrating the hypothesised foam blanket's cooling effect.

The ground temperature under the foam blanket said thermal semi-conducting junction 24, which is reapplied daily during daylight, depresses the peak air temperature caused by solar warming mid day 26 and the foam evaporates slowly and settles and compacts under further aerosol foam application in chilling cooler air. Aerosol spraying can be carried out only when the trees jets and roots are unfrozen, namely during daylight hours mostly PM in the summer season 25. The foam blanket overlaid reduces diurnal solar variations in ground temperature and increases solar reflection to cool the underlying permafrost during periods of perpetual daylight thus reducing the melting rate of the permafrost shown by down-arrows whilst allowing warmer anaerobic biomass processes to continue insulated within the foam above the ground.

Foam-containing CO2 will eventually chill when the bioactive processes complete and fall making contact with cold ground ice as a liquid slush and thereby maintain a gradual steady ground and ice slush CO2 sorbing at around 0 deg. C 27 with the foam blanket remaining above preventing boil-off as it freezes. Subsequent water sprays will collapse the chilling foam and sandwich-in CO2 in ice as the foam compacts against the ground. By suspending roots on floating rafts above and over ground, the ice layers can be built up over slush without trapping the roots, allowing the units to be re-planted upstream as described—refer to FIG. 18. Using a compressed CO2 colloid propellant with some environmentally neutral minimum surfactant, emulsified oil, alcohol and salt content will depress the freezing point to allow the devices to operate with their interconnected roots resting on the ground or floating ice sheets at 0 deg C whilst remaining frozen. Suspending the roots above ground pushes the operational boundaries further. Advantageously, by using bio-active colloids the fermenting wort will continue to produce some heat in the insulated roots and foam blankets, providing some minimum level of self-propellant spraying capability from a heated central header tank, dependent on air temperature.

1. A climate processor with one or more virtual estuaries comprising: two long strips of chilling white artificial and or natural surfaced terrain masses bounding a central wide strip of cooled moistened terrain mass forming an icewalled thermal channel made to behave like a real estuary of water thermo-dynamically to conduct weather systems overhead providing a means of combined climate control streaming greening zoning irrigation cooling and stabilisation.

2. An climate processor with one or more virtual estuaries forming an icewalled thermal channel as claimed in claim 1 wherein said icewalling comprises a cold firewall made of ice slush raised terrain and or snow at or below 0 degrees C. and or an artificial surface whitening or high solar reflectance of unspecified surface temperature material and altitude with a persistence limited to hours days or weeks able to provide night time thermal breathing and daytime thermal blocking.

3. A climate processor with two or more virtual estuaries as claimed in claims 1 and 2 forming planet rings applied sequentially bisecting or trisecting two or more larger adjacent terrain masses of differing latitudes altitudes terrain and or climates receiving significantly different levels of solar warming in sequence to provide said means of climate control zoning cooling and stabilisation.

4. A climate processor with one or more virtual estuaries as claimed in claim 1 and above wherein said central wide strip of cooled terrain mass forming an ice-walled channel has a seasonal and diurnal temperature variation that is reduced in amplitude and lagged in time by aerial moisture conveyance overhead and by its subsequent precipitation onto said channel surface making it moist and behave like water thermodynamically with said adjacent bisected terrain masses that behave as normal land thermodynamically with greater differential said variations and shorter lag times.

5. A climate processor with one or more virtual estuaries comprising artificial and or natural terrain boundings of chilling white artificial surfaced terrain masses as claimed in claims 1 and 2 wherein said masses are made to behave like snow permafrost or ice surfaced terrain forming chilling white icewalls as virtual estuary container banks in summer.

6. A climate processor with one or more virtual estuaries comprising artificial and or natural terrain boundings of chilling white artificial surfaced terrain masses as claimed in claim 4 wherein said chilling white walls are made from solar reflective and insulative foams applied in the summer mornings which persist over noon and decay in the afternoon heat.

7. A climate processor with one or more virtual estuaries comprising two long narrower strips of chilled white walled artificial and or natural terrain masses bounding a central wider strip of cooled terrain mass forming a channel as claimed in claim 1 capable of conducting a diurnal and seasonal switched climate stream including weather systems along and above it in a similar way to switched electric current through a gated n or p-channel MOSFET in one direction where the lateral flow of isotherms across the channel is gated or switched off or made thermally semi-conducting in summer daytime by said artificial or natural bounding terrain masses forming surface chilling thermal junctions.

8. A climate processor with one or more virtual estuaries comprising a central wider channel of cooled terrain as claimed in claim 1 that is maintained in a self-perpetuating moistened state through the conduction of a climate stream overhead as claimed in claim 6.

9. A climate processor with virtual estuaries that bisect adjacent warmer cooler and larger terrain masses with a central channel terrain mass as claimed in claim 1 with leading and trailing edge white wall bounding terrain masses wherein said trailing edge forms a summer fall-back cold location to prevent the season-on-season retreat of a snowline isotherm ice sheet or ice shelf or desertification advancing beyond said trailing edge.

10. A climate processor with virtual estuaries as claimed in claim 1 comprising a central channel forming a slowly-warming seasonal summer daytime heatsink breather bounded by white walled diurnal heatsink-switched daytime chilling blockers as claimed in claim 3 and above that store less heat more rapidly during a hot day and release stored heat re-radiating it out into space during successive cooler nights as breathers.

11. A climate processor with virtual estuaries as claimed in claim 1 and with heatsink-switched daytime blockers as claimed in claim 9 that persist in their blocking action over several 24-hr polar summer days.

12. A climate processor with virtual estuaries as claimed in claims 1 2 and above comprising thermal junctions that thermally de-couple said bisected land masses from each other through the formation of thermals air curtains and sinks overhead to prevent adjacent isotherm migration and climate intermixing between said larger adjacent land masses.

1. A Climate Processor with a versatile multi-role aircraft comprising a means of delivering heavy and or bulky water based and other cargoes including fuel and CO2 over terrain comprising one or more:—hovercraft with a harnessed ex-commercial jet aircraft, docking airships and a means of combined cargo processing propulsion lift and delivery system.

2. A Climate Processor with a versatile multi-role aircraft comprising a means of delivering heavy water and other cargoes over terrain comprising a hovercraft as claimed in claim 1 operating in its heavier-than-air hover flight role wherein said hovercraft supports heavy fresh water salt water fuel surfactant and other cargoes over said terrain with a hover cushion.

3. A Climate Processor with a versatile multi-role aircraft comprising a means of delivering bulky cargoes over terrain comprising one or more docking airships as claimed in claims 1 and 2 operating in its light-as-air flight role wherein said airships support un-docked the delivery of fuel water surfactant and other cargoes over said terrain.

4. A Climate Processor with a versatile multi-role aircraft comprising a means of delivering heavy and bulky cargoes over terrain as claimed in claims 1 2 and 3 operating in multiple roles sequentially to include water for greening water and surfactant for laying virtual estuaries water surfactant and carbon dioxide for fire fighting and carbon offsetting and fuel as mined gas.

5. A Climate Processor with a versatile multi-role aircraft comprising a means of delivering heavy and or bulky water based and other cargoes including fuel over terrain comprising one or more:—hovercraft with harnessed commercial jet aircraft as claimed in claim 1 and above wherein said hovercraft deploys said aircraft in its heavier-than-air flight role which may be old of low fuel efficiency un flight-worthy surplus to commercial fleet requirements and re-cycled for supplying skirted cushion lift forward propulsion and flight systems.

6. A Climate Processor with a versatile multi-role aircraft comprising a means of delivering heavy and or bulky water based and other cargoes including fuel over terrain comprising a combined cargo processing propulsion lift and delivery system as claimed in claim 1 and above that recovers said aircraft jet engine exhaust heat to evaporate by boiling solar-heated seawater said cargo into steam and said jet engine turbojet cold airflow to condense said steam into fresh water providing the first stage said combined cargo processing lift and propulsion means.

7. A Climate Processor with a versatile multi-role aircraft comprising a combined cargo processing propulsion lift and delivery as claimed in claim 1 that mixes fresh water surfactant CO2 cargoes in said propulsion systems ducted fan air to produce a blown CO2 white reflective insulating foam and air cushion spread flat over terrain under cushion skirt to provide the second stage of said combined cargo processing lift and propulsion means.

8. A Climate Processor with a versatile multi-role aircraft comprising a combined cargo processing propulsion lift and delivery system as claimed in claims 1 6 and 7 that sources its foam cushion from either fresh and or salt water cargoes with a facility to replenish its stores over remote terrain to include pumping and scooping water and or ice onboard from lakes seas icecaps and or rivers.

9. A Climate Processor with a versatile multi-role aircraft in it's light-as-air flight role as claimed in claims 1 and 3 for transporting flammable gas bulk fuel cargoes safely over terrain when mixed with the non-flammable helium lift gas within the same internal gas chamber sacks held within said airships propelled by processed said gas or other fuel.

10. A Climate Processor with a versatile multi-role cargo transport aircraft in it's light-as-air flight role as claimed in claim 1 for transporting the CO2 gas cargo with the helium lift gas held in separate gas chamber sacks.

11. A Climate Processor with a versatile multi-role cargo transport aircraft as claimed in claim 1 and above able to lay long wide shallow foam belts over mixed terrain to include isotherms estuaries mountain ridges valleys coast lines thaw-threatened permafrost strudel scour receding snowlines desertification forests tree lines greening forest fires and fragmenting-threatened thawing polar ice sheets.

12. A Climate Processor with a versatile multi-role cargo transport aircraft as claimed in claim 1 and above able to lay long wide shallow belts over mixed terrain as claimed in claim 11 to include moisture for laying along central land breathers for virtual estuaries.

1. A Climate Processor with a high level civil aviation propellant system comprising a Russian doll sorber that generates rapidly precipitating reduced CO2 emission moist dense white solar reflective jet contrails from stores of fuels and oxidants.

2. A Climate Processor with a high level civil aviation propellant system comprising a Russian doll sorber that generates rapidly precipitating reduced CO2 emission moist dense white solar reflective jet contrails as claimed in claim 1 with one or more:—short chain aliphatic and alcohol fuel mixtures held in pumpable gelled substrate and in fixed foam substrate stores and one or more aqueous oxidant gelled solutions held in one or more pumped gelled media in fixed foam substrate stores.

3. A Climate Processor with a high level civil aviation propellant system comprising a Russian doll sorber that generates rapidly precipitating reduced CO2 emission moist dense white solar reflective jet contrails as claimed in claims 1 and 2 including a fuel containing a variable ingredient mixture of primarily hydrophilic shorter chain alcohols including methanol ethanol propanol and butanol and an oxidant burn rate activated moderator containing aqueous hydrogen peroxide solution.

4. A Climate Processor with a high level civil aviation propellant system comprising a Russian doll sorber that generates rapidly precipitating reduced CO2 emission moist dense white solar reflective jet contrails as claimed in claims 1 2 and 3 including a variable ingredient mixture of fuels with a mixture of sorbed hydrophobic fuel fluids including hydrogen, methane, ethane, propane, butane, pentane and hexane.

5. A Climate Processor with a high level civil aviation propellant system comprising a Russian doll sorber that generates rapidly precipitating reduced CO2 emission moist dense white solar reflective jet contrails as claimed in claims 1 to 4 including an ingredient mixture of hydrophobic fuels including septane octane nonane decane duodecane pentadecane hexadecane and primarily hydrophobic alcohols including pentanol hexanol septanol octanol nonanol and decanol.

6. A Climate Processor with a high level civil aviation propellant system comprising a Russian doll sorber that generates rapidly precipitating reduced CO2 emission moist dense white solar reflective jet contrails as claimed in claim 1 wherein said propellant includes a hydrophobic headed fuel mixture including primarily kerosene as claimed in claim 5 floating above partially solved in a hydrophilic tailed fuel mixture of alcohols including primarily a concentrated aqueous methanol solution as claimed in claim 3 with centrally suspended intermediate inter-miscible mixture members forming a tri-state traffic light fuel cocktail.

7. A Climate Processor with a high level civil aviation propellant system comprising a Russian doll sorber that generates rapidly precipitating reduced CO2 emission moist dense white solar reflective jet contrails as claimed in claims 1 and 6 wherein said tri-state fuel product is complimented with a pressurised partially sorbed volatile fuel gas propellant mixture as claimed in claim 4.

8. A Climate Processor with a high level civil aviation propellant system comprising a Russian doll sorber that generates rapidly precipitating reduced CO2 emission moist dense white solar reflective jet contrails as claimed in claims 1 and above with a means of location speed sequence and altitude-based variable propellant deployment achieved by varying the proportions and hence geometry to include the flame speed kinematics of the combusting fuel and oxidant ingredient mixtures as the propellant is drawn from within stores as claimed in claim 7 and from between multiple stores as claimed in claims 2 and 8.

9. A Climate Processor with a high level civil aviation propellant system comprising a Russian doll sorber that generates rapidly precipitating reduced CO2 emission moist dense white solar reflective jet contrails as claimed in claim 1 with multiple fuel stores as claimed in claim 8 wherein each store comprises a fuel or fuel mixture optimised for location speed sequence and altitude-based multi-stage deployment forming a multiple-redundant store array.

10. A Climate Processor with a high level civil aviation propellant system comprising a Russian doll sorber that generates rapidly precipitating reduced CO2 emission moist dense white solar reflective jet contrails as claimed above with one or more collapsible-walled expanding foam-filled stores that are inter-pumped and filled via top-mounted feeder tubes facilitating top-down deployment and air-tight evacuation for sequential top-down variable-geometry fuel traffic light mixture deployment.

11. A Climate Processor with a high level civil aviation propellant system comprising a Russian doll sorber that generates rapidly precipitating reduced CO2 emission moist dense white solar reflective jet contrails as claimed in claim 1 with in-engine propellant mixture mixing and metering to include separate autonomous multiple redundant fuel and oxidant store lines pumps and injectors in said engines combustion chambers.

1. A Climate Processor with a carbon micro credit-trading system providing means of promoting carbon capture and offsetting forming a commercial location-based modus operandi for diverting airline flights overhead and for energy companies on the surface based on redeemable public-private micro-credits.

2. A Climate Processor with a carbon micro credit-trading system promoting greener flight as claimed in claim 1 wherein said micro-credits are earned publicly for passenger air miles flown along prescribed latitude-following paths including virtual and real estuaries rain forests valleys climactic streams desertification seasonal isotherms and according to lie of land whilst deploying low CO2 emission wet-burning rapidly precipitating propellants.

3. A Climate Processor with a carbon micro credit-trading system promoting greener flight as claimed in claim 1 wherein flights diverted from their great circle routes to fly as prescribed in claim 2 earn private micro-credits for additional passenger miles flown.

4. A Climate Processor with a carbon micro credit-trading system promoting greener flight as claimed in claim 1 wherein said public micro-credits are earned for flights flown as claimed above in summer daytime AM.

5. A Climate Processor with a carbon micro credit-trading system providing a means of promoting greener flight as claimed in claim 1 wherein overnight flights deploying kerosene earn public micro-credit debits.

6. A Climate Processor with a carbon micro credit-trading system providing carbon capture and offsetting forming a commercial location-based modus operandi for energy companies as claimed in claim 1 wherein said micro-credits are earned privately for foam belt miles laid forming white ice walled banks of prescribed latitude-following paths over mixed terrain in summer.

7. A Climate Processor with a carbon micro credit-trading system providing a means of promoting carbon capture and offsetting forming a commercial location-based modus operandi for energy companies as claimed in claim 1 wherein said micro-credits are earned privately per Tonne CO2 captured by airships at power stations transported to virtual estuarial and prescribed latitudinal polar geo-locations and successfully laid as foams in late summer and autumn.

1. A Climate Processor with a tunnelling Russian doll gas sorber store comprising a decouplable physical level and molecular level gas sorbing store with a contiguous up-structure deployed in a volatile fuel or other mixture to provide a means of holding supersaturated volatile gases and or CO2 sorbed in liquid solutions and sorbed progressively through semi-solid gel-emulsions into particulate suspensions deeper within the store forming pumpable and fixed substrates held in stable said tunnelling Russian doll containment.

2. A Climate Processor with a tunnelling Russian doll gas sorber store with a contiguous up-structure as claimed in claim 1 wherein said contiguous up-structure comprises a progression of increasingly smaller nested containers progressing from macro physical structures through micro to nano-scale molecular or chemical level structural containment thereby providing a means of preventing bubble-seeding of gases out of super-saturated solution.

3. A Climate Processor with a tunnelling Russian doll gas sorber deployed in a volatile gel fuel mixture to provide a means of holding supersaturated gases in liquid solutions as claimed in claims 1 and above wherein said up-structures are non-contiguous chemically but contiguous physically to include gelled emulsions and mixtures of nested oils alcohols natural and synthetic gels and solid particulates

4. A Climate Processor with a tunnelling Russian doll gas sorber as claimed above wherein blends of contiguous family member particularly the aliphatic series are mixed with blends of non-contiguous members particularly alcohols to promote cross-bonding between different solutes and solutions to include emulsions of particulates and emulsions of oils and alcohols set in viscous gels to include and promote ionic to covalent cross-medium bonding facilitating said gas tunnelling into porous and metal-coated particulates with high BET surface areas.

5. A Climate Procesor with a tunneling Russian doll gas sorber with a contiguous up-structure as claimed above that can sorb volatile CO2 gas and VOCs into non-combustible substrates to include water-based gels and particulates.

1. A Climate Processor with a range of gel foams that can be deployed in an aerosol or in a blower that act as thermal breather-blockers suitable for applying on terrain surfaces that inflate and decay at predetermined rates causing said surface whitening cooling insulation evaporative moisture retention and shade comprising product propellant ingredient mixtures to include water.

2. A Climate Processor with a range gel foams that can be deployed in an aerosol or in a blower that act as thermal breather-blockers suitable for deploying on terrain surfaces as claimed in claim 1 that provide temporary cover insulation warmth nutrients and irrigation for greening and anaerobic digester composting at pre-determined rates.

3. A Climate Processor with a gel foam aerosol comprising a product-propellant ingredient mixture as claimed in claims 1 and 2 wherein said mixture includes organic and or synthetic ingredients including Russian doll sorbers.

4. A Climate Processor with a gel foam aerosol comprising a product propellant ingredient mixture as claimed above that has its ingredient mixture dilution viscosity and propellant pressure empirically determined to inflate on reaching the ground subsequent to aerosol deployment to provide maximum surface sticktion and minimum wind resistance to prevent it blowing away when deployed aerially from moderate altitudes speeds and in cross wind.

5. A Climate Processor with a gel foam aerosol comprising a product propellant ingredient mixture as claimed above wherein said foam constituency is empirically determined to include deployment suitability from a typical low-flying crop sprayer a multi-role aircraft in hover role and or a ground-based aerial sprinkler nozzle deployment system over terrain.
